(19) United States
(12) Patent Application Publication
(10) Pub. No.: US 2025/0123244 A1
(43) Pub. Date: Apr. 17, 2025

(54) Ultrasonic Sensor

(71) Applicant: Shenzhen Dauxi Vision Technologies Co., Ltd, Shenzhen (CN)

(72) Inventor: Qing Xiao, Shenzhen (CN)

(21) Appl. No.: 18/916,803

(22) Filed: Oct. 16, 2024

(30) Foreign Application Priority Data
Oct. 16, 2023 (CN) 202322787057.8
Oct. 16, 2023 (CN) 202322791963.5
Feb. 4, 2024 (CN) 202410163491.5
May 23, 2024 (CN) 202421144955.X
Oct. 14, 2024 (CN) 202422484864.7

(51) Int. Cl. G01N 29/24; G01N 29/22

(52) U.S. Cl. CPC G01N 29/2406; G01N 29/223; G01N 2291/101

(57) ABSTRACT

The invention relates to an ultrasonic sensor, which includes a housing. The housing is provided with a supporting part inside, as well as a connecting opening that connects to the outside environment. It also includes a first planar electrode and a second planar electrode, which are arranged on the supporting part and positioned opposite to each other. The first planar electrode is at least partially in contact with the second planar electrode, and both are insulated from each other to form a stable planar capacitor. The first planar electrode comprises an insulating film and a first conductive layer, which is arranged on one side of the insulating film. The second planar electrode comprises a conductive substrate. This ultrasonic sensor replaces the piezoelectric ceramic plate with the first and second planar electrodes to form a planar capacitor, thus avoiding the technical defects caused by the production technology of piezoelectric ceramic plates.

### CROSS REFERENCE TO RELATED APPLICATIONS

The present application claims the benefit of Chinese Patent Application Nos. 202322787057.8 filed on Oct. 16, 2023, 202421144955.X filed on May 23, 2024, 202410163491.5 filed on Feb. 4, 2024, 202322791963.5 filed on Oct. 16, 2023 and 202422484864.7 filed on Oct. 14, 2024. All the above are hereby incorporated by reference in their entirety.

### FIELD

The present invention relates to the field of sensor technology, and particularly relates to an ultrasonic sensor.

### BACKGROUND

An ultrasonic sensor is a type of sensor that utilizes sound wave media to perform non-contact, non-wear detection of the target object.

In the related technology, ultrasonic sensors primarily consist of a metal housing and a piezoelectric ceramic plate installed inside the metal housing. The piezoelectric ceramic plate can both emit and receive ultrasonic waves. However, current manufacturing technology for piezoelectric ceramic plates presents several challenges, including multiple and complex process steps, low yield rates, poor consistency of the center frequency of piezoelectric ceramics, leading to low production capacity, high costs, and significant material waste.

### SUMMARY

The technical problem to be solved by the present invention is to provide an improved ultrasonic sensor.

The technical solution adopted by the present invention to solve the technical problem is to construct an ultrasonic sensor comprising: a cylindrical housing, a supporting part inside the housing, and a connecting opening that connects with the outside environment; a first planar electrode positioned on the supporting part and placed opposite the connecting opening; a second planar electrode arranged opposite the first planar electrode, wherein a surface of the second planar electrode is at least partially affixed to a surface of the first planar electrode backward to the supporting part, and are insulated from each other to form a stable planar capacitor; wherein the first planar electrode includes an insulating film and a first conductive layer arranged on the insulating film; the second planar electrode comprises at least a conductive substrate; and the first conductive layer is insulated from the conductive substrate.

In some embodiments, the insulating film is a plastic film with a thickness range of 1 μm to 50 μm; the first conductive layer is a metal layer attached to the surface of the plastic film, with a thickness range of 1 nm to 20 μm.

In some embodiments, the conductive substrate is a PCB circuit board; or, the conductive substrate is a metal plate, with a thickness range of 0.001 mm to 20 mm.

In some embodiments, the first conductive layer is arranged on the side of the insulating film facing the second planar electrode, and an insulating layer is provided between the first conductive layer and the conductive substrate, with the insulating film isolating the first conductive layer from the external environment.

In some embodiments, the second planar electrode is provided with at least one groove on the surface facing the first planar electrode, and the at least one groove is located at the edge of the second planar electrode, and the ultrasonic sensor further comprises a conductive plate supplying power to the first planar electrode, and the conductive plate is arranged on the side of the first planar electrode facing away from the supporting part, adhering to the first conductive layer.

In some embodiments, the first conductive layer is arranged on the side of the insulating film facing away from the second planar electrode; the ultrasonic sensor further comprises an flexible printed circuit, the flexible printed circuit including a first conductive part electrically connected to the first conductive layer and a third conductive part for connecting to an electrical signal; the first conductive part is positioned between the first planar electrode and the supporting part, and the third conductive part transmits electrical signals to the first conductive layer through the first conductive part.

In some embodiments, the flexible printed circuit further comprises a second conductive part electrically connected to the conductive substrate; the third conductive part transmits electrical signals to the conductive substrate through the second conductive part.

In some embodiments, the surface of the second planar electrode facing the first planar electrode is provided with a silkscreen layer or recesses for forming a textured structure.

In some embodiments, the ultrasonic sensor further comprises a pressing ring, which is installed on the surface of the first planar electrode facing the second planar electrode; furthermore, a snap-fit structure is provided between the pressing ring and the housing to press the first planar electrode tightly onto the supporting part.

In some embodiments, the snap-fit structure comprises several elastic channels arranged circumferentially on the pressing ring and several first locking blocks arranged circumferentially on the inner side of the housing corresponding to the elastic channels; some sidewalls of each elastic channel have elastic deformation capability, and the width of the opening of the elastic channel farthest from the first planar electrode is smaller than the length of the first locking block; the pressing ring utilizes the elasticity of the sidewalls of the elastic channel to pass over the first locking block and snap into the side of the first locking block facing the first planar electrode; wherein the channel end wall formed around the opening of the elastic channel abuts the first locking block.

In some embodiments, the pressing ring further comprises a receiving area on the side of the elastic channel opposite to the first planar electrode, the first locking block passing through the elastic channel is positioned within the receiving area, and it can contact the sidewall of the receiving area to limit the circumferential displacement of the pressing ring; the pressing ring comprises a ring body and several sets of snap-fit components arranged circumferentially around the ring body; each set of snap-fit components includes two snap members arranged at intervals along the circumference of the ring body, with the elastic channel and receiving area formed between the two snap members; wherein the deformation state of the elastic channel is: each of the two is inclined in a direction away from the other, or, two sidewalls of the two snap members facing each other are clastic walls.

In some embodiments, the snap-fit structure includes several inclined wedges arranged circumferentially around the periphery of the pressing ring, and several first locking blocks arranged circumferentially on the inner side of the housing corresponding to the elastic channels; each inclined wedge has a pre-assembly state and an assembly state, wherein the pre-assembly state has the inclined wedge at least partially positioned at the same height as the first locking block, and the assembly state is when the pressing ring rotates circumferentially around the housing, causing the inclined wedge to snap into the side of the first locking block facing the supporting part.

In some embodiments, the ultrasonic sensor includes a spring assembly fixed relative to the side of the second planar electrode facing away from the first planar electrode, abutting the second planar electrode, and applying a force to press the second planar electrode tightly against the first planar electrode; the spring assembly includes a main body part and at least one first elastic part positioned between the main body part and the second planar electrode, wherein the first elastic part has elastic deformation capability and is in a compressed state when the main body part is fixed on one side of the second planar electrode, thereby achieving tight pressing.

In some embodiments, each side of the main body part is provided with a first snap-fit structure and a second snap-fit structure with respect to the pressing ring to fix the spring assembly to the pressing ring; wherein the first snap-fit structure comprises two second locking positions arranged at intervals along the circumference of the pressing ring, and two connecting arms extending from the main body part to correspond to the second locking positions, the two connecting arms having elastic deformation capability, which allows them to move closer together in a deformed state to enter the corresponding second locking positions, and snap into the second locking positions in a natural state; the second snap-fit structure is structurally identical to the first snap-fit structure; alternatively, the second snap-fit structure comprises a plug set on either the main body part or the pressing ring, and a second mounting slot set on the other, where the plug is inserted into the second mounting slot.

In some embodiments, the pressing ring is provided with a first mounting slot for the two connecting arms to partially insert, and two bumps are set on the walls of the first mounting slot to form two second locking positions; each connecting arm has a slot at the top, and the slot snaps onto the bumps after part of the connecting arm is inserted into the first mounting slot; or, the pressing ring comprises a ring body and two hook-shaped parts positioned on the side of the ring body opposite the first planar electrode, wherein the two hook-shaped parts are L-shaped and form the second locking positions respectively, and the two hook-shaped parts are mirror-symmetrically arranged in the circumferential direction of the pressing ring; each connecting arm is further provided with a snap part for insertion into the second locking positions.

In some embodiments, the spring assembly comprises multiple first clastic parts, which are arranged at intervals between the main body part and the second planar electrode; alternatively, the spring assembly comprises a single first clastic part and two second elastic parts positioned on both sides of the main body part in the width direction; the second clastic parts have elastic deformation capability and are in a deformed state when the main body part is fixed on the second planar electrode, thereby achieving tight pressing; the second elastic parts include contact parts for abutting the second planar electrode, and connecting parts linking the contact parts to the main body part; there is a distance between the contact parts and the plane of the main body part, and one end of the connecting parts, which are connected to the contact parts, moves relative to the plane of the main body part when the contact parts are pressed, generating elastic force.

In some embodiments, the ultrasonic sensor further comprises a control board for outputting electrical signals; the control board is installed on the side of the spring assembly opposite to the second planar electrode; the two connecting arms are each provided with extension parts extending from the control board on the side opposite to the pressing ring, and the extension parts have snap corners that hold part of the control board between the two extension parts; the control board is further provided with at least one insertion part for insertion into the elastic channel.

In some embodiments, the ultrasonic sensor further comprises a control board for outputting electrical signals; a third snap-fit structure is provided between the pressing ring and the control board for mounting the control board onto the pressing ring; wherein the outer circumferential edge of the control board is provided with several relief notches arranged at intervals along the circumference, and the third snap-fit structure comprises a solid structure located between two adjacent relief notches on the control board, and a first locking position formed on the pressing ring, with the solid structure snapping into the first locking position.

In some embodiments, the ultrasonic sensor further comprises a mesh cover, which is detachably mounted on one end of the housing close to the first planar electrode; a fixing structure is provided between the mesh cover and the housing to fix the mesh cover to the housing; the mesh cover includes a curved surface, and the curved surface is provided with multiple mesh holes; wherein the curved surface is a convex structure protruding outward from the ultrasonic sensor, or a concave structure recessed inward toward the ultrasonic sensor.

In some embodiments, the multiple mesh holes are evenly distributed on the curved surface; wherein the distance L1 between the two opposite sides of each mesh hole is in the range of 2.8 mm to 3.5 mm, and/or the distance L2 between the nearest two points of two adjacent mesh holes is in the range of 0.6 mm to 1 mm, and/or the thickness T1 of the curved surface is in the range of 0.5 mm to 1 mm; moreover, the mesh cover further comprises an annular mounting portion set at the peripheral edge of the curved surface; wherein the height H1 from the highest point of the curved surface to the end face of the mounting portion is in the range of 0.5 mm to 1.5 mm, or, the depth H2 from the lowest point of the curved surface to the end face of the mounting portion is in the range of 0.5 mm to 1.5 mm.

The ultrasonic sensor of the present invention replaces the piezoelectric ceramic plate with the first and second planar electrodes to form a planar capacitor, avoiding the technical defects caused by the production technology of piezoelectric ceramic plates.

### BRIEF DESCRIPTION OF THE DRAWINGS

The invention will be further described below in conjunction with accompanying drawings and embodiments. In the drawings:

FIG. 1 is a longitudinal sectional view of an ultrasonic transducer of the present invention in Embodiment 1;

FIG. 2 is a longitudinal sectional view of the ultrasonic transducer of the present invention in Embodiment 2;

FIG. 3 is a schematic structural diagram of a surface of the second planar electrode facing the first planar electrode in Embodiment 1 of the present invention;

FIG. 4 is a schematic structural diagram of the surface of the second planar electrode facing the first planar electrode in Embodiment 2 of the present invention;

FIG. 5 is a longitudinal sectional view of the ultrasonic transducer of the present invention in Embodiment 1-1;

FIG. 6 is a structural exploded view of the ultrasonic transducer of the present invention in Embodiment 1-1;

FIG. 7 is a longitudinal sectional view of the ultrasonic transducer of the present invention in Embodiment 2-1;

FIG. 8 is an exploded view of the structure of an ultrasonic transducer of the present invention in Embodiment 2-1;

FIG. 9 is a schematic diagram of the structure of the housing of the ultrasonic transducer of the present invention in some embodiments;

FIG. 10 is a schematic diagram of the structure of the first planar electrode to be mounted on the housing shown in FIG. 9 in Embodiment 1-1 of the present invention;

FIG. 11 is a schematic structural diagram of a conductive plate being mounted on the first planar electrode shown in FIG. 10 in Embodiment 1-1 of the present invention;

FIG. 12 is a schematic diagram of a structure in Embodiment 1-1 of the present invention in which a press-fit structure and a second planar electrode are mounted in the housing shown in FIG. 11;

FIG. 13 is a schematic diagram of a structure in Embodiment 2-1 of the present invention in which an FPC wire is mounted on the housing shown in FIG. 9;

FIG. 14 is a schematic diagram of the structure of the FPC wire of some embodiments of the present invention before it is assembled;

FIG. 15 is a schematic structural diagram of the first planar electrode being mounted on the FPC wire shown in FIG. 13 in Embodiment 2-1 of the present invention;

FIG. 16 is a schematic diagram of the structure of the press-fit structure and the second planar electrode in the housing shown in FIG. 15 in Embodiment 2-1 of the present invention;

FIG. 17 is a schematic diagram of the structure of a compression ring of the press-fit structure of the present invention in Embodiment 2-1;

FIG. 18 is a schematic diagram of the structure of the press ring of the press-fit structure of the present invention in Embodiment 2-2;

FIG. 19 is a schematic diagram of the structure of the compression spring assembly to be mounted on the compression ring shown in FIG. 16 in Embodiment 2-1 of the present invention;

FIG. 20 is a schematic structural diagram of a portion of the compression spring assembly of the present invention as structured in Embodiment 2-1;

FIG. 21 is a schematic structural diagram of the compression spring assembly of the present invention partially structured in Embodiment 1-1;

FIG. 22 is a longitudinal sectional view of the partial structure of the compression spring assembly shown in FIG. 21;

FIG. 23 is a schematic view of the structure of the compression spring assembly to be mounted on the compression ring shown in FIG. 12 in Embodiment 1-1 of the present invention;

FIG. 24 is a schematic view of the structure of the main control board being mounted on the compression spring assembly shown in FIG. 19 in Embodiment 2-1 of the present invention;

FIG. 25 is a schematic diagram of the structure shown in FIG. 24 at another angle;

FIG. 26 is a schematic diagram of a structure in which the main control board is mounted on a compression ring in Embodiment 2-3 of the present invention;

FIG. 27 is a cross-sectional view of the structure of the back cover mounted on the housing in some embodiments of the present invention;

FIG. 28 is a schematic structural view showing the ultrasonic sensor with the mesh cover and housing separated, omitting the internal structure of housing 3;

FIG. 29 is a longitudinal sectional view of the mesh cover with a convex structure in some embodiments of the present invention;

FIG. 30 is a top view showing the structure of the mesh cover with a convex structure in some embodiments of the present invention;

FIG. 31 is a waveform diagram showing three experimental conditions: an ultrasonic sensor without a mesh cover, an ultrasonic sensor with a flat mesh cover, and an ultrasonic sensor with a convex mesh cover;

FIG. 32 is a longitudinal sectional view of the mesh cover with a concave structure in some embodiments of the present invention.

Reference numerals in the drawings are:

Ultrasonic sensor 100; First planar electrode 1; Insulating film 11; First conductive layer 12; Second planar electrode 2; Conductive substrate 21; Insulating layer 22; Silkscreen layer 221; Groove 23; Dent 24; Outer housing 3; First end 31; Connecting opening 311; Second end 32; Supporting part 33; Second sealing ring 331; Limiting block 34; First locking block 35; Second locking block 36; Limiting groove 37; Third locking block 38; Positioning strip 39; Connection electrode 4; Conductive plate 41; Through-slot 411; Plated through hole 412; Flexible printed circuit 42; First conductive part 421; Second conductive part 422; Third conductive part 423; Electrode contact 4231; Pressing structure 5; Pressing ring 51; Ring body 511; First ring section 5111; Second ring section 5112; Elastic channel 512; End wall of channel 5121; Clearance slot 513; Receiving area 514; Glue injection point 515; Locking member 516; Head section 5161; Foot section 5162; Shoulder section 5163; First locking position 517; Protrusion 518; First mounting slot 519; Bump 520; Second locking position 521; Second mounting slot 522; Hook-shaped part 523; Seal 53; Inclined wedge 54; Sloping surface 541; Force surface 542; Protuberance 55; Spring assembly 6; Main body part 61; First elastic part 62; First contact surface 621; Connecting arm 63; Snap part 631; Extension part 632; Snap corner 6321; Groove 633; Plug 64; Groove 65; Protruding shaft 66; Wing sections 67; Second elastic part 68; Second contact surface 681; Contact part 682; Connecting part 683; Main control board 7; Relief notch 71; Two-pin connector cable 72; Relief position 73; Control wire 74; Insertion part 75; Back cover 8; Back plate 81; Cylindrical section 82; Positioning slot 821; Raised boss 83; Scaling ring 84; Nut 85; Elastic washer 86; Rubber sleeve 87; Screw tube 88; Mesh cover 9; Locking slot 91; Curved surface portion 92; Mesh hole 921; Mounting portion 93; Flat part 931; Assembly part 932.

### DESCRIPTION OF THE EMBODIMENTS

In the following description, specific details such as particular system structures and technologies are provided for better understanding of the embodiments of the present invention. However, those skilled in the art will understand that the present invention can also be implemented in other embodiments without these specific details.

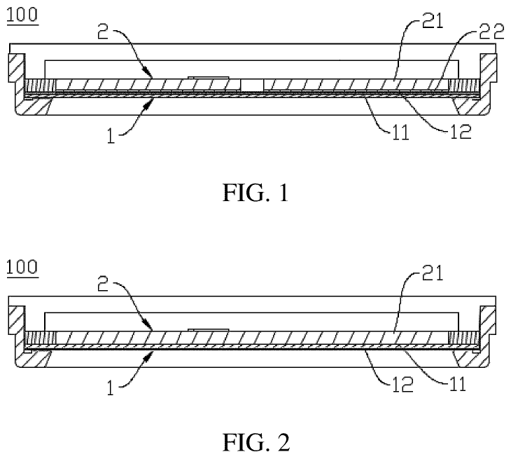

Referring to FIG. 1 or FIG. 2, the present invention provides an ultrasonic sensor 100, which is a capacitive ultrasonic sensor. The sensor 100 includes at least a first planar electrode 1 and a second planar electrode 2, where the first planar electrode 1 is positioned face-to-face with the second planar electrode 2. The two electrodes are at least partially in contact but are insulated from each other. They form a planar capacitor together, and create an electric field between them.

When a pulse electric field or alternating electric field of a certain frequency is applied to the planar capacitor, the first planar electrode 1 vibrates vertically to generate ultrasonic waves. These ultrasonic waves are emitted from the side of the first planar electrode 1 that faces away from the second planar electrode 2. Alternatively, the first planar electrode 1 vibrates under the influence of external ultrasonic waves, causing the capacitance between the first planar electrode 1 and the second planar electrode 2 to change, generating a detectable electrical signal.

The ultrasonic sensor 100 of the present invention uses the interaction between the first planar electrode 1 and the second planar electrode 2 to replace the piezoelectric ceramic plate, forming a planar capacitor. This configuration avoids the technical defects associated with the production of piezoelectric ceramic plates. Moreover, the manufacturing process for the first planar electrode 1 is simple, cost-effective, and results in high yields, making rapid manufacturing feasible. Additionally, using a capacitive ultrasonic transducer narrows the ultrasonic beam angle.

The first planar electrode 1 is a planar structure (refer to FIG. 1), typically circular in shape, although other shapes are also possible and are not limited here.

In some embodiments, the first planar electrode 1 can be made of a metal film. The better the flexibility and the thinner the metal, the more sensitive the ultrasonic sensor 100 becomes. Different thicknesses of the metal film can correspond to different ultrasonic frequencies.

In a more preferred embodiment, as shown in FIG. 1 or FIG. 2, the first planar electrode 1 may include an insulating film 11 and a first conductive layer 12 deposited on the insulating film 11. Optionally, the thickness of the insulating film 11 may range from 1 μm to 50 μm, with a preferred range between 6 μm and 25 μm, for example, between 5 μm and 20 μm, such as 8 μm, 10 μm, 12.5 μm, 15 μm, or 18 μm. The thickness of the first conductive layer 12 may range from 1 nm to 20 μm, for example, 100 nm, 0.5 μm, 1 μm, or 5 μm. Additionally, the insulating film 11 may be made of polymer material, such as plastic film. The plastic film material can be one selected from PC, PVC, ABS, PE, PP, BOPP, PET, or polyethylene, or a combination of at least two of these materials. The first conductive layer 12 may be a metal layer made of materials such as aluminum, gold, or copper.

It is understood that if a metal film is used directly as the first planar electrode 1, the crystalline structure of the metal film may become brittle at low temperatures (e.g., between −40° C. and 0° C.), as the metal crystal structure changes. The metal's atomic lattice vibrations decrease, and the atomic spacing shrinks, making atomic displacement easier, thereby reducing the metal's ductility and toughness. Consequently, the performance of the first planar electrode 1 made from a metal film is slightly lower. Additionally, the metal's crystal structure may change from a face-centered cubic structure to a body-centered cubic structure at low temperatures, further reducing the metal's ductility and toughness, ultimately diminishing the film's vibration performance and sensitivity.

In this preferred embodiment, by attaching a metal layer to a plastic film, the advantages of the metal layer's electrical properties are combined with the mechanical properties of the plastic film, allowing the first planar electrode 1 to have excellent sensitivity and longer service life with better weather resistance.

Optionally, as shown in FIG. 1, the first conductive layer 12 can be placed on the side of the insulating film 11 that faces the second planar electrode 2 (Embodiment 1). Alternatively, as shown in FIG. 2, the first conductive layer 12 can be positioned on the side of the insulating film 11 that faces away from the second planar electrode 2 (Embodiment 2). It is understood that when the first conductive layer 12 is between the insulating film 11 and the second planar electrode 2, the first conductive layer 12 needs to be insulated from the second planar electrode 2. However, if the insulating film 11 is between the first conductive layer 12 and the second planar electrode 2, the insulating film 11 serves as the insulating layer between the first conductive layer 12 and the second planar electrode 2.

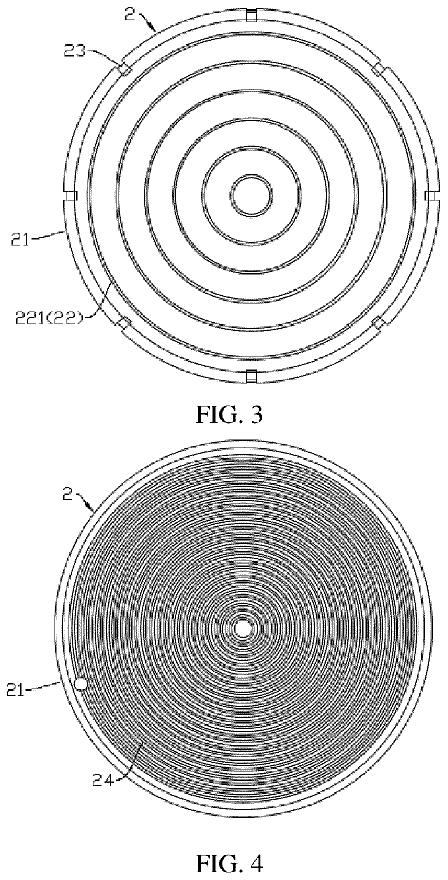

Please refer to FIG. 3 or FIG. 4. The second planar electrode 2 may be a circular planar structure, though it can also be other shapes, ideally matching the shape of the first planar electrode 1.

In the Embodiment 1, referring to FIG. 3, the second planar electrode 2 can include a conductive substrate 21 and an insulating layer 22 positioned on the side of the conductive substrate 21 facing the first planar electrode 1. The insulating layer 22 ensures insulation between the second planar electrode 2 and the first planar electrode 1. Of course, the insulating layer 22 can also be positioned on the side of the first conductive layer 12 that faces away from the insulating film 11. In this case, the insulating layer 22 can serve as an insulating barrier between the first conductive layer 12 and the conductive substrate 21. Preferably, the surface of the insulating layer 22 facing the first planar electrode 1 is uneven to effectively prevent vacuum adhesion between the second planar electrode 2 and the first planar electrode 1.

The conductive substrate 21 can include a base material and a second conductive layer (This feature is not shown in the drawings) on the surface of the base material facing the first planar electrode 1. The insulating layer 22 is disposed on the surface of the second conductive layer that faces the first planar electrode 1. Optionally, the conductive substrate 21 can be a printed circuit board (PCB), and the second conductive layer can be a copper coating on the PCB. The PCB can be a double-layer or a four-layer board. Alternatively, the conductive substrate 21 can be a conductive metal plate, and the metal plate thickness can range from 0.001 mm to 20 mm. When the metal plate is thicker, the sensitivity of the ultrasonic sensor is higher. The preferred thickness range is 0.8 mm to 2 mm. The insulating layer 22 can be placed on the surface of the metal plate facing the first planar electrode 1. It is understood that PCBs are suitable for fast and efficient manufacturing due to their mature technology and low cost, whereas metal plates contain more metal atoms, allowing them to store more charge. When a metal plate is used to manufacture the second planar electrode 2, the sensitivity of the ultrasonic sensor is relatively higher.

In the Embodiment 1, the insulating layer 22 can include an insulating oil layer applied to the conductive substrate 21 and/or a silkscreen layer 221 printed on the conductive substrate 21 (refer to FIG. 3). Optionally, the insulating layer 22 includes an insulating oil layer (This feature is not shown in the drawings) laid on the conductive substrate 21 and a silkscreen layer 221 printed on the insulating oil layer. There is a thickness difference between the insulating oil layer and the silkscreen layer 221. For example, the silkscreen layer 221 can be arranged in concentric circles, multiple rectangles, or parallel vertical stripes, creating a height difference. The double insulation provided by the insulating oil layer and the silkscreen layer 221 enhances the reliability of the insulation because the insulating oil layer is relatively thin (e.g., green oil), and over time, it may wear out and lose its insulating properties. Meanwhile, the silkscreen layer 221 helps prevent vacuum adhesion between the second planar electrode 2 and the first planar electrode 1, ensuring better performance.

Further, with continued reference to FIG. 2, the edges of the second planar electrode 2 that face the first planar electrode 1 can be rounded to effectively prevent the detachment of the first conductive layer 12. It is understood that during operation, the first and second planar electrodes vibrate repeatedly, and the areas of the first conductive layer 12 corresponding to the edges of the second planar electrode 2 bear the most force, making them prone to abrasion and detachment, which can reduce the sensitivity of the ultrasonic sensor 100. By rounding the edges of the second planar electrode 2, the risk of detachment of the first conductive layer 12 can be effectively mitigated. More preferably, at least one groove 23 is provided on the surface of the second planar electrode 2 facing the first planar electrode 1, and the groove 23 is positioned at the edge of the second planar electrode 2. This design ensures that, regardless of how long the sensor operates, the part of the first planar electrode 1 corresponding to the groove 23 does not contact any hard objects, allowing for reliable conduction between the second planar electrode 2 and the first planar electrode 1. This ensures the long-term stability of the ultrasonic sensor 100.

In Embodiment 2, as shown in FIG. 4, the insulating film 11 can act as the insulating layer between the first conductive layer 12 and the second planar electrode 2. Hence, the second planar electrode 2 may only consist of the conductive substrate 21, which could be a conductive metal plate, such as aluminum, copper, or stainless steel. Preferably, multiple dents 24 are provided on the surface of the conductive substrate 21 facing the first planar electrode 1 to prevent vacuum adhesion between the second planar electrode 2 and the first planar electrode 1.

Additionally, in both Embodiment 1 and Embodiment 2, the surface of the second planar electrode 2 opposite the first planar electrode 1 may be equipped with pads for connecting electrical signals. These pads may also be placed on the surface of the second planar electrode 2 facing the first planar electrode 1.

To summarize, the first planar electrode 1 and the second planar electrode 2 are securely laminated together, making contact without short-circuiting, and forming a stable planar capacitor.

In practical applications, the second planar electrode 2 can serve as the positive electrode and the first planar electrode 1 as the negative electrode, each connected to the output terminals of a signal source. For example, the ultrasonic sensor 100 can include two electrode wires, with one wire's end mechanically and electrically connected to the pad on the second planar electrode 2, and the other wire's end connected directly or indirectly to the first planar electrode 1. The polarity of the first and second planar electrodes is interchangeable. After applying a pulsed or alternating electric field of a certain frequency to the electrodes, the first planar electrode 1 vibrates vertically to generate ultrasonic waves. Particularly, when the first planar electrode 1 is constructed by attaching a metal layer to a plastic film, the voltage change can drive the metal layer to vibrate. As the metal layer is tightly attached to the plastic film, the plastic film will also vibrate, causing air molecules to generate ultrasonic waves. Compared to using a direct metal film for the first planar electrode 1, this construction method results in better performance.

It is understood that, in Embodiment 1, because the side of the first planar electrode 1 facing the outside is the surface of the plastic film, it is more resistant to corrosion. Furthermore, the molecular bonds of the plastic film are unaffected by low temperatures, allowing the first planar electrode 1 to function normally even at temperatures as low as −40° C. In Embodiment 2, using the insulating film 11 as the insulating layer between the first conductive layer 12 and the conductive substrate 21 reduces the thickness between the first and second planar electrodes, improving the sensitivity of the ultrasonic sensor 100.

Additionally, the diameter of the first and second planar electrodes can be adjusted according to needs. For example, by increasing the diameter of the electrodes, the ultrasonic sensor 100 can achieve greater sensitivity because the capacitance increases with larger electrode areas. Alternatively, reducing the diameter can meet the need for a more compact ultrasonic sensor 100.

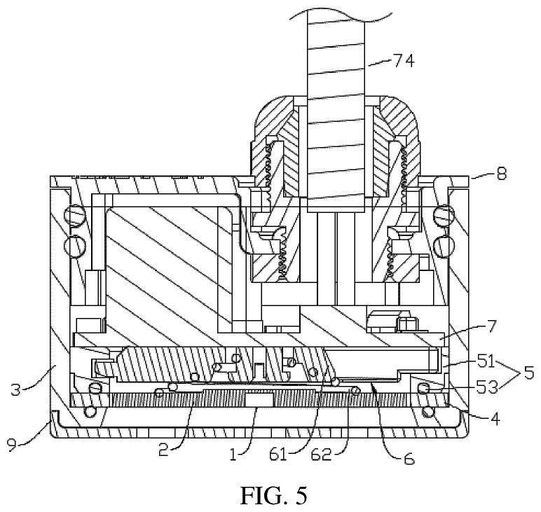

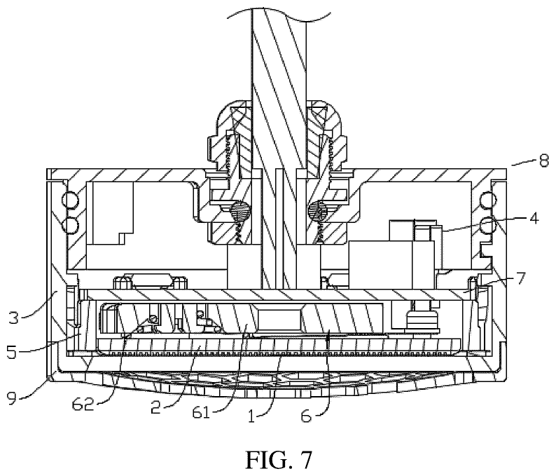

Refer to FIGS. 5-8 for Embodiment 1-1 and Embodiment 2-1, which illustrate specific structures of ultrasonic sensors 100 using the planar electrode configurations described in Embodiment 1 and Embodiment 2, respectively. Both embodiments of the ultrasonic sensor 100 share similar basic structures, with minor differences in certain components.

Wherein, whether Embodiment 1-1 or Embodiment 2-1, the ultrasonic sensor 100 may also include an outer housing 3, a connection electrode 4, a compression structure 5, a spring assembly 6, a control board 7, a back cover 8, and a mesh cover 9, in various combinations. These components are not essential for the ultrasonic sensor 100 to produce ultrasonic waves, but they serve as preferred options for various embodiments.

The outer housing 3 provides a foundation for mounting and protecting the first and second planar electrodes. The connection electrode 4 supplies electricity to the first planar electrode 1, while the compression structure 5 tightly connects the connection electrode 4 with the first planar electrode 1. The spring assembly 6 ensures a secure fit between the first and second planar electrodes. The control board 7 provides the appropriate alternating current signal to both electrodes, and the back cover 8 seals the housing 3. Finally, the mesh cover 9 serves to protect the first planar electrode 1. It should be noted that the planar electrodes do not necessarily rely on the connecting electrode 4 for conduction; they can also be directly connected to the main control board 7 via electrode wires, and this is not limited to any specific configuration.

Here is a detailed explanation of these components:

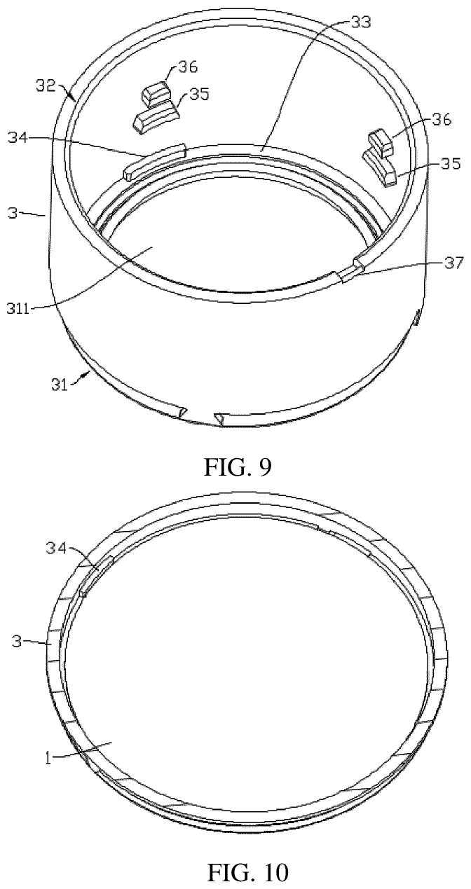

Referring to FIG. 9, the outer housing 3 is cylindrical, with a first end 31 that allows sound waves to pass through, and an opposing second end 32. Both ends are open.

For the convenience of explanation in this scheme, the position of the first end 31 or the area near the first end 31 is referred to as the bottom, while the position of the second end 32 or the area near the second end 32 is referred to as the top. Of course, the area near the first end 31 can also be regarded as the top, and the area near the second end 32 can be regarded as the bottom, without being limited to this specific configuration.

As shown in FIG. 9, the outer housing 3 is equipped with a support section 33 to hold the first planar electrode 1 and has a connecting opening 311 that opens to the outside world. When the first planar electrode 1 is positioned on the support section 33, it faces the connecting opening 311, blocking it.

The support section 33 is ring-shaped and located at the bottom of the outer housing 3. The connecting opening 311 is formed at the bottom of the outer housing. An additional sealing ring 331 may be embedded in the support section 33 to prevent glue from leaking when applied and to stop electrical conduction to the outer housing 3.

Additionally, several first locking blocks 35 may be spaced circumferentially along the inner sidewall of the outer housing 3. These blocks are used to fit with the compression structure 5. In this embodiment, there are four first locking blocks 35 positioned above the support section 33. Of course, the number of first locking blocks 35 can be at least one, as long as the contact area between the first locking block 35 and the compression structure 5 is sufficient to ensure the stability of the compression structure 5.

And, several second locking blocks 36 may be spaced circumferentially along the inner sidewall of the housing 3, intended to cooperate with the back cover 8 to secure it to the top of the housing 3. These second locking blocks 36 are positioned above the first locking blocks 35 and maintain a vertical distance from them. In this embodiment, there are four second locking blocks 36 inside the housing 3. Optionally, the length of the second locking blocks 36 may be equal to or less than the length of the first locking blocks 35.

The top end wall of the housing 3 may also include a limiting groove 37, designed to cooperate with the back cover 8 to prevent it from rotating freely, thus ensuring that the back cover 8 remains securely fixed once installed.

Next, we will describe the first planar electrode 1 in Embodiment 1-1 and Embodiment 2-1 in detail:

In Embodiment 1-1, as shown in FIG. 10, the assembly relationship between the first planar electrode 1 and the housing 3 is demonstrated. To simplify the diagram, only a portion of the housing 3 structure is shown in FIG. 10, and the same applies to other diagrams mentioned below. In this embodiment, the first planar electrode 1 is placed flatly on the supporting part 33, with its diameter larger than the inner diameter of the supporting part 33 but smaller than the inner diameter of the housing 3. The insulating film 11 of the first planar electrode 1 is positioned close to the connecting opening 311. In other words, the first planar electrode 1 is directly installed on the supporting part 33, with its insulating film 11 blocking the connecting opening 311, thereby isolating the first conductive layer 12 from external influences, effectively preventing environmental factors from affecting the first conductive layer 12. Since the first conductive layer 12 is isolated from external exposure, its resistance to corrosion and its service life are improved, especially when the insulating film 11 is made of plastic, providing the ultrasonic sensor 100 with excellent waterproof and corrosion-resistant properties.

Referring to FIG. 11 the connection electrode 4 may consist of a conductive plate 41 positioned on top of the first planar electrode 1, adhering to and electrically connecting with the first conductive layer 12 of the first planar electrode 1. The conductive plate 41 also serves to press the first planar electrode 1 onto the supporting part 33, ensuring that the first planar electrode 1 is tightly fitted with the supporting part 33. Moreover, after assembly, the conductive plate 41 is located below the first locking blocks 35, maintaining a certain vertical distance from them.

In this embodiment, the conductive plate 41 may have a ring shape, such as a circular ring, with its outer diameter matching the inner diameter of the housing 3, while its inner diameter is smaller than the diameter of the first planar electrode 1. During assembly, the conductive plate 41 is coaxially aligned with the first planar electrode 1. The conductive plate 41 can be made entirely of a conductive metal material, such as aluminum, copper, or gold. Of course, the conductive plate 41 is not limited to being made entirely of conductive material, and it can also be produced by coating the surface of a non-conductive material with a conductive layer. The conductive layer may be made of materials such as aluminum, copper, or gold.

Referring to FIG. 9, the conductive plate 41 may be provided with several through-slots 411, whose number corresponds to the number of first locking blocks 35 and second locking blocks 36. Each through-slot 411 penetrates through the upper and lower surfaces of the outer edge of the conductive plate 41. During assembly, the conductive plate 41 is inserted into the housing 3 from the second end 32 and, through these through-slots 411, smoothly passes over the first locking blocks 35 and the second locking blocks 36, eventually reaching the top of the first planar electrode 1. At the same time, the inner side of the housing 3 may be equipped with a limiting block 34 to prevent the conductive plate 41 from rotating freely, effectively ensuring that the conductive plate 41 remains fixed relative to the first planar electrode 1. The limiting block 34 may be positioned on the inner sidewall of the housing 3 and located at the top of the supporting part 33. One of the through-slots 411 of the conductive plate 41 can be placed over the limiting block 34, restricting the lateral movement of the conductive plate 41 and ensuring that the first planar electrode 1 does not move during assembly, thus maintaining its integrity. In this embodiment, the conductive plate 41 has four through-slots 411 located at its periphery.

The conductive plate 41 may also be equipped with plated through hole 412, designed for mechanical and electrical connection with electrode wires, enabling the connection between the first planar electrode 1 and the control board 7. In this embodiment, the plated through hole 412 are semi-circular holes located on the periphery of the conductive plate 41.

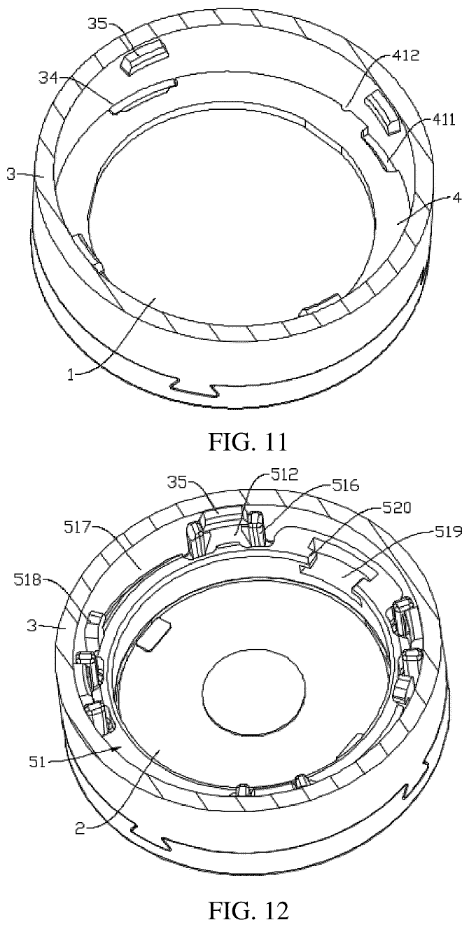

Additionally, in Embodiment 1-1, the diameter of the second planar electrode 2 is smaller than or equal to the inner diameter of the conductive plate 41. After assembly, referring to FIG. 12, the second planar electrode 2 is positioned inside the inner circumference of the conductive plate 41 and adheres to the first planar electrode 1. The insulating layer 22 is situated between the first conductive layer 12 and the conductive substrate 21. The second planar electrode 2 can be electrically connected to the control board 7 via an electrode wire.

Looking immediately at Embodiment 2-1, the first conductive layer 12 is arranged adjacent to the connecting opening 311 with in the housing 3. It can be understood that while blocking the connecting opening 311 with the insulating film 11 isolates the first conductive layer 12 from the outside environment, this configuration requires insulation between the first conductive layer 12 and the conductive substrate 21, which increases the thickness between the second planar electrode 2 and the first planar electrode 1 (It is understandable that, in some embodiments, the second planar electrode 2 can be a PCB, and the green oil layer on the PCB can serve as insulation. However, since the green oil layer is relatively thin, an additional insulating layer is often added to ensure insulation between the planar electrodes. As a result, there is a relatively large thickness between the second planar electrode 2 and the first planar electrode 1), reducing the sensitivity of the ultrasonic sensor 100. However, if the first conductive layer 12 is positioned facing the connecting opening 311, the insulating film 11 can act as an insulating layer between the first conductive layer 12 and the conductive substrate 21, reducing the overall thickness between the second planar electrode 2 and the first planar electrode 1, thus improving the sensitivity of the ultrasonic sensor 100.

Preferably, to prevent corrosion of the first conductive layer 12 due to external factors, a protective layer can be applied on the side of the first conductive layer 12 facing the connecting opening 311 (This feature is not shown in the drawings), such as an oxide layer, may be applied to the surface of the first conductive layer 12.

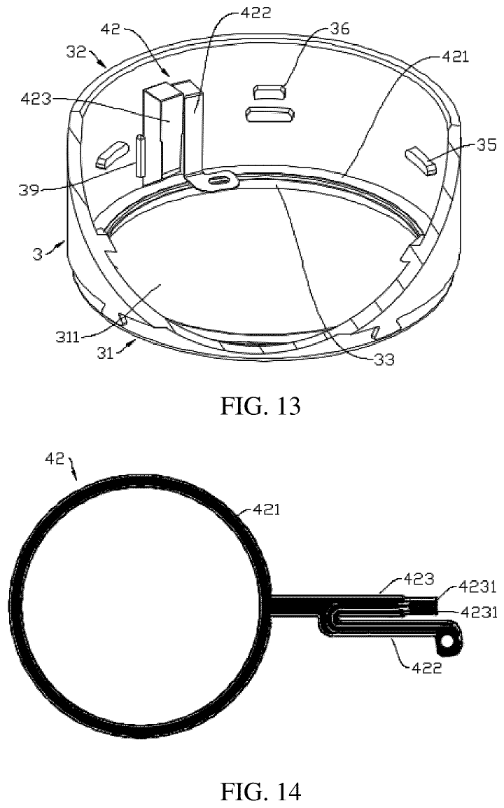

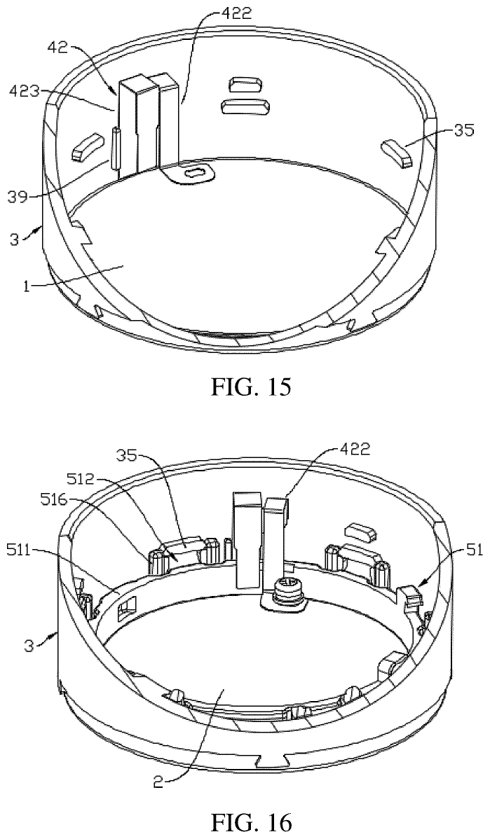

In this Embodiment 2-1, the connection electrode 4 can be a flexible printed circuit 42. As shown in FIG. 13, the flexible printed circuit 42 may include a first conductive portion 421, a second conductive portion 422, and a third conductive portion 423. As shown in FIG. 13, the first conductive portion 421 is used to electrically connect with the first planar electrode 1 and may be ring-shaped, positioned on the supporting part 33. As shown in FIG. 15, the first planar electrode 1 is placed on top of the first conductive portion 421, meaning that the first conductive portion 421 is positioned between the supporting part 33 and the first conductive layer 12. The outer diameter of the first conductive portion 421 is less than or equal to the inner diameter of the housing 3, and its inner diameter is greater than or equal to the inner diameter of the supporting part 33.

As shown in FIG. 14, the second conductive portion 422 and the third conductive portion 423 are both elongated structures. The third conductive portion 423 is integrally connected to the first conductive portion 421 and extends outward from it, while the second conductive portion 422 is integrally connected to the third conductive portion 423. The second conductive portion 422 is used to electrically connect to the second planar electrode 2, and the third conductive portion 423 is used to connect with the control board 7 to receive electrical signals. The third conductive portion 423 is equipped with at least two electrode contacts 4231, with one electrode contact 4231 electrically connected to the first planar electrode 1 and the other electrode contact 4231 electrically connected to the second planar electrode 2. Of course, electrode contacts 4231 can also be replaced with solder pads. It should be noted that the flexible printed circuit 42 is made of a flexible material, capable of bending. In FIG. 13, the second conductive portion 422 and the third conductive portion 423 are already bent, but during the actual assembly process, they may initially remain elongated, as shown in FIG. 14, to facilitate the installation of the first planar electrode 1 and other components. When necessary, the second conductive portion 422 and/or the third conductive portion 423 can be bent into a suitable shape, such as U-shaped or L-shaped.

As shown in FIG. 16, one end of the second conductive portion 422 extends toward the side of the second planar electrode 2 facing away from the first planar electrode 1 and is fixed to the second planar electrode 2 using fasteners such as screws. The third conductive portion 423 extends and inserts into a predefined port on the control board 7 (This feature is not shown in the drawings) to establish a connection with it. After the third conductive portion 423 receives an electrical signal, it transmits the signal through the first conductive portion 421 to the first planar electrode 1 and through the second conductive portion 422 to the second planar electrode 2.

Preferably, the inner sidewall of the housing 3 is provided with a positioning strip 39 to ensure proper placement of the second conductive portion 422 and the third conductive portion 423 during assembly, facilitating quick installation.

From Embodiments 1-1 and 2-1, it can be seen that by changing the relative positions of the first conductive layer 12 and the insulating film 11, the sensitivity and stability of the ultrasonic sensor 100 can be adjusted.

Next, we look at the structure of the pressing assembly 5. For brevity, the following description will focus on the planar electrode configuration in Embodiment 2-1. It should be noted that the pressing assembly 5 serves to press down the first planar electrode 1, and its setup is unaffected by the planar electrode configuration, whether in Embodiment 1-1 or Embodiment 2-1.

Referring to FIG. 16, the pressing assembly 5 is placed on top of the first planar electrode 1, pressing the first planar electrode 1 and the first conductive portion 421 into the housing 3. The pressing assembly 5 may be annular, such as a circular ring, with its maximum outer diameter matching the inner diameter of the housing 3, and its inner diameter greater than or equal to the diameter of the second planar electrode 2. The second planar electrode 2 is positioned inside the inner circumference of the pressing assembly 5. Here, it should be noted that in Embodiment 1-1, as shown in FIG. 12, the pressing assembly 5 is placed on top of the connection electrode 4, pressing the first planar electrode 1 and the conductive plate 41 into the housing 3.

The pressing assembly 5 may include a pressing ring 51. Optionally, the pressing assembly 5 may also include a seal 53 embedded at the bottom of the pressing ring 51, which can have the effect of sealing, e.g. for preventing leakage of liquids.

Furthermore, as shown in FIG. 16, the pressing ring 51 may include a ring body 511, which serves as the foundation for pressing the first planar electrode 1 and the connection electrode 4. A locking structure is set between the ring body 511 and the inner sidewall of the housing 3 to lock the ring body 511 above the first planar electrode 1.

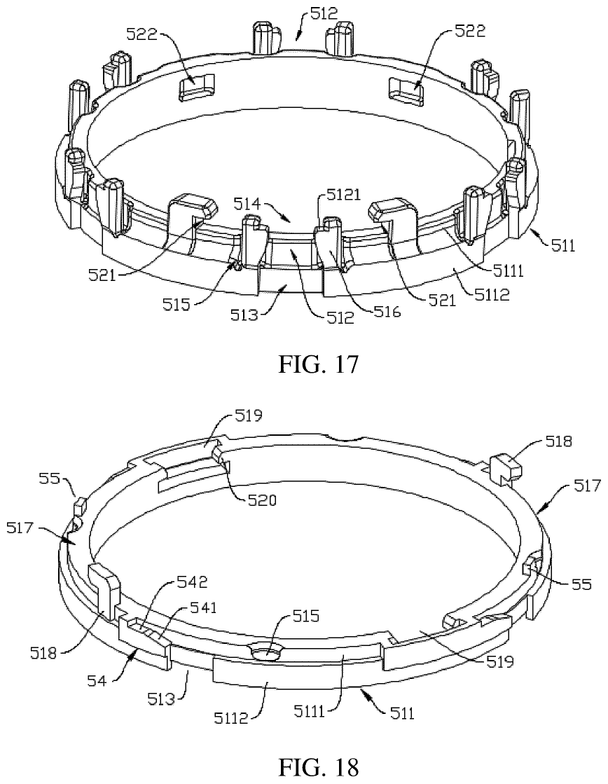

Refer to FIGS. 16 and 17, which illustrate the locking structure in Embodiment 2-1. The locking structure consists of several elastic channels 512 formed along the circumference of the outer periphery of the ring body 511, spaced apart at intervals, and several first locking blocks 35 located circumferentially along the inner sidewall of the housing 3. These elastic channels 512 correspond one-to-one with each of the first locking blocks 35 and second locking blocks 36 during assembly. Each elastic channel 512 has an upper opening whose diameter is smaller than the length of the first locking block 35. However, the sidewalls of the elastic channel 512 have elastic deformation capabilities, allowing the first locking block 35 to pass through smoothly. After passing through the first locking block 35, the clastic channel 512 returns to its original shape, and the end wall of channel 5121 of the channel opening rests against the first locking block 35, restricting the ring body 511 between the first planar electrode 1 and the first locking block 35. Of course, the reduced diameter section could be at any part of the elastic channel 512, not necessarily at the top opening.

The thickness between the end wall of channel 5121 of the channel and the bottom of the seal 53 (in its natural state) is greater than or equal to the distance between the first locking block 35 and the installed first planar electrode 1, thus applying pressure to the first planar electrode 1. In cases where no seal 53 is provided, the thickness between the end wall of channel 5121 and the bottom of the ring body 511 must still be greater than or equal to the distance between the first locking block 35 and the installed first planar electrode 1.

Optionally, the clastic deformation capability of the elastic channel 512 can be that the entire sidewall of the elastic channel 512 tilts when under pressure and returns to its original state after pressure is removed; that is, the sidewalls on both sides of the elastic channel 512 are pushed open by the first locking block 35, causing the sidewalls to tilt away from each other. Of course, the elastic deformation ability can also mean that the sidewalls of the elastic channel 512 at the point of force indentation deform and return to their original shape after the force is removed; in this case, the sidewalls of the elastic channel 512 act as elastic walls, and the part of the sidewall that comes into contact with the first locking block 35 will indent and deform. Of course, the elastic deformation ability can also mean that the sidewalls of the elastic channel 512 at the point of force indentation deform and return to their original shape after the force is removed; in this case, the sidewalls of the elastic channel 512 act as elastic walls, and the part of the sidewall that comes into contact with the first locking block 35 will indent and deform.

In other words, the opposing sidewalls of the elastic channel 512 would be pushed apart by the first locking block 35, causing each sidewall to tilt away from each other. The elastic deformation can also occur through a localized indentation on the sidewall where the first locking block 35 presses against it. That is, the sidewall of the elastic channel 512 is an elastic membrane that deforms locally under pressure.

As shown in FIG. 17, the ring body 511 may also be provided with several clearance slots 513 located below each elastic channel 512. These clearance slots 513 extend from the lower end of the clastic channel 512 (the end closer to the first planar electrode 1) and allow the first locking block 35 to pass through and into the elastic channel 512. The length of the clearance slots 513 is greater than or equal to the length of the first locking block 35. These clearance slots 513 are not essential to the pressing ring 51. In embodiments without the clearance slots 513, the lower end of the clastic channel 512 directly extends to the corresponding position.

The ring body 511 may also have a receiving area 514 positioned above each elastic channel 512. The receiving area 514 connects to the upper opening of the clastic channel 512 and is used to accommodate the first locking block 35 after it passes through the elastic channel 512. The sidewall of the receiving area 514 cooperates with the first locking block 35 to restrict rotational movement of the ring body 511, thereby stabilizing the position of the first planar electrode 1. The length of the receiving area 514 is preferably the same as the length of the first locking block 35.

In this Embodiment 2-1, as shown in FIG. 17, the elastic channel 512 is provided with a first opening (relative to the lower end opening) and a second opening (relative to the upper end opening). The first opening is positioned closer to the first end 31 of the housing 3. The width of the first opening is greater than or equal to the length of the first locking block 35, while the second opening is smaller than the first opening and smaller than the length of the first locking block 35.

The ring body 511 consists of a first ring section 5111 and a second ring section 5112, where the first ring section 5111 is positioned above the second ring section 5112. The first ring section 5111 is further away from the first planar electrode 1 than the second ring section 5112, and the outer diameter of the first ring section 5111 is smaller than that of the second ring section 5112, while their inner diameters can be equal. Multiple sets of locking components are arranged at intervals around the circumference of the first ring section 5111, with each set forming an elastic channel 512. Each set of locking components may include two symmetrically arranged locking members 516 that are spaced apart along the circumference of the ring body 511. These two locking members 516 form the sidewalls of the clastic channel 512 and a receiving area 514 between them. Preferably, to facilitate the passage of the first locking block 35, the sidewalls of the elastic channel 512 formed by the two locking members 516 are at least partially smoothly slanted. The clearance slots 513 are spaced around the second ring section 5112; in this embodiment, four clearance slots 513 are evenly distributed on the second ring section 5112.

Multiple locking assemblies are circumferentially spaced along the first ring section 5111. Each locking assembly forms an elastic channel 512. Preferably, for case of passage through the first locking block 35, at least part of the sidewalls forming the elastic channel 512 of each locking assembly is smoothly inclined. Clearance slots 513 are circumferentially spaced along the second ring section 5112. In this embodiment, four clearance slots 513 are uniformly distributed around the second ring section 5112.

As shown in FIG. 17, each locking member 516 consists of a head section 5161, a foot section 5162, and a shoulder section 5163 located between the head section 5161 and the foot section 5162. The foot section 5162 is fixedly connected to the top of the second ring section 5112 (Equivalent to the locking piece 516 standing at the middle thickness of the ring body 511, which is conducive to the miniaturization of the entire sensor). The head section 5161 is positioned above the foot section 5162. The shoulder section 5163 projects laterally from one side of the locking member 516, forming a step with the head section 5161. The top wall of the shoulder section 5163 corresponds to the aforementioned end wall of channel 5121. The gap between the foot sections 5162 of two adjacent locking members 516 forms the first opening, which is sized to allow the first locking block 35 to pass through. That means, the gap between the foot section 5162 of the two locking members 516 in the same group forms the first opening, and the length of the first opening is greater than or equal to the length of the first locking block 35, preferably equivalent to the length of the clearance slots 513. The gap between their shoulder sections 5163 forms the second opening, which is smaller than the first opening. The gap between the head sections 5161 forms the receiving area 514, whose length corresponds to the length of the first locking block 35. After the first locking block 35 passes through the elastic channel 512, it is housed in the receiving area 514, where the head sections 5161 and shoulder sections 5163 cooperate to restrict the movement of the ring body 511, preventing movement both circumferentially and axially.

Additionally, as shown in FIG. 17, the ring body 511 may be equipped with one or more glue injection points 515, used to fill the gaps formed between at least two of the components-such as the housing 3, the pressing ring 51, the seal 53, the connection electrode 4, and the first planar electrode 1. It is understood that the nozzle of a glue injector can be inserted into the glue injection points 515 to fill these gaps with glue. Once the glue solidifies, the first planar electrode 1 is firmly bonded to the supporting part 33. This ensures that the first planar electrode 1 can withstand the pressure from the second planar electrode 2 and remain in place, ensuring the smooth operation of the ultrasonic sensor 100. Moreover, it can also ensure that the surface of the first planar electrode 1 is basically flat, and the fitting pressure given by the second planar electrode 2 is also conducive to the flat surface of the planar electrode, so that if the first planar electrode 1 is wrinkled, the generation of ultrasonic waves is affected. The glue can also prevent the pressing ring 51 from loosening due to rotation, improving the reliability of the assembly and enhancing the waterproofing performance. It is preferable to use polyurethane potting glue, known for its excellent flow and adhesion properties, which solidifies with high hardness.

In Embodiment 2-1, as shown in FIG. 17, each slot at the position of the locking members 516 on the first ring section 5111 can form a glue injection point 515. The sidewalls of these slots and the adjacent locking members 516 maintain a distance, forming a glue injection point 515 around the locking member 516. This ensures that, once the glue solidifies, the locking member 516 remains fixed in place, preventing the first locking block 35 from moving through the elastic channel 512 again.

Additionally, in the present application, besides using elastic channels 512 to secure the ring body 511, another embodiment is provided to achieve the locking of the ring body 511. As shown in FIG. 18, in Embodiment 2-2, several inclined wedges 54 are set on the outer circumference of the ring body 511 to engage with the first locking block 35, pressing the ring body 511 below the first locking block 35.

As shown in FIG. 18, the inclined wedges 54 are circumferentially spaced around the outer circumference of the ring body 511 and are designed to engage with the side of the first locking block 35 facing the supporting part 33. It is understood that a single inclined wedge 54 and a single first locking block 35 together form a locking structure, pressing the ring body 511 tightly against the connection electrode 4 and the first planar electrode 1. Of course, the locking structure is not limited to the inclined wedge 54 and the first locking block 35. For instance, the inner circumferential side of the housing 3 may have a slot for the inclined wedge 54 to engage, and together they would form a locking structure.

Each inclined wedge 54 has a sloping surface 541 and a force surface 542. The sloping surface 541 helps guide the force surface 542 to rotate under the first locking block 35, where the sloping surface 541 inclines toward the closest first locking block 35. The lower side of the sloping surface 541 is adjacent to the closest first locking block 35 closest to the inclined wedge 54, while the higher side of the sloping surface 541 connects to the force surface 542. The force surface 542 is flat and arranged parallel to the bottom surface of the first locking block 35.

For example, the seal 53 is embedded in the ring body 511 and may slightly protrude. During assembly, the ring body 511 passes smoothly through the first locking blocks 35 via the clearance slots 513 and is placed over the top of the first planar electrode 1. At this point, at least part of the sloping surface 541 of the inclined wedge 54 is positioned below the first locking block 35. The ring body 511 is then rotated, moving the inclined wedge 54 toward the nearest first locking block 35. The sloping surface 541 first contacts the first locking block 35, pushing the ring body 511 downward, compressing the seal 53, and shortening the distance between the force surface 542 and the connection electrode 4. As the ring body 511 rotates further, the force surface 542 eventually contacts the bottom surface of the first locking block 35, completing the pressing process, which securely tightens the first planar electrode 1. Of course, the process can be completed even if the seal 53 does not protrude, depending on the gap between the force surface 542 and the connection electrode 4 and the distance between the first planar electrode 1 and the bottom of the first locking block 35 before pressing.

In Embodiment 2-2, the glue injection points 515 can also be positioned on the first ring section 5111 and connected to the open spaces formed between the first ring section 5111 and the second ring section 5112. Optionally, the outer surface of the inclined wedge 54 may extend beyond the outer surface of the second ring section 5112, allowing glue to flow into the gaps.

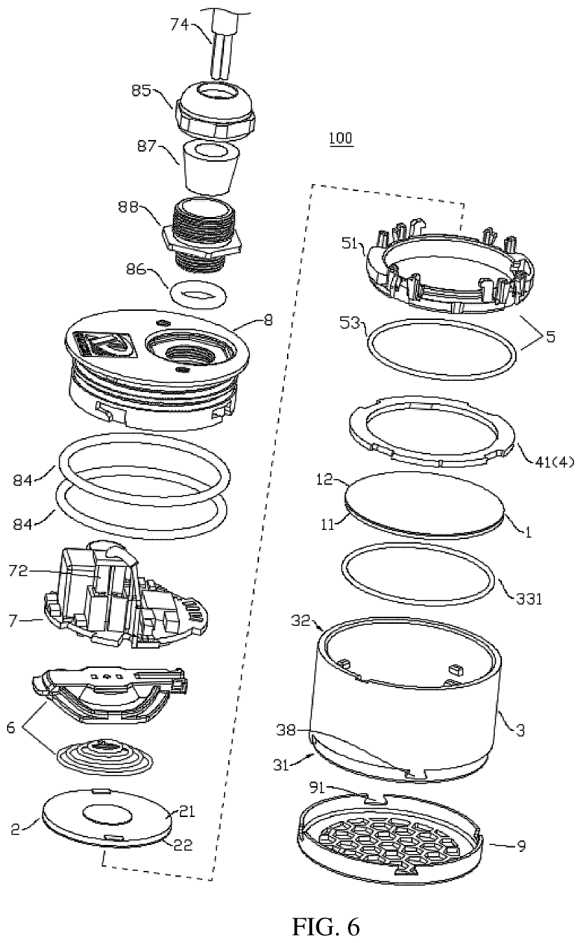

Immediately following the description of the structure of the seal 53, referring back to FIG. 5 and FIG. 6, the figure illustrates the use of the seal 53 in Embodiment 1-1 to enhance the seal. And, the seal 53 is ring-shaped and embedded into a ring groove (This feature is not shown in the drawings) recessed at the bottom of the ring body 511. In this embodiment, the ring groove is formed in the second ring section 5112. After the seal 53 is embedded into the ring body 511, it may partially protrude, and during assembly, the seal 53 is compressed, ensuring full contact between the seal 53 and the first planar electrode 1, guaranteeing a scaling effect. Optionally, the seal 53 may be a silicone ring.

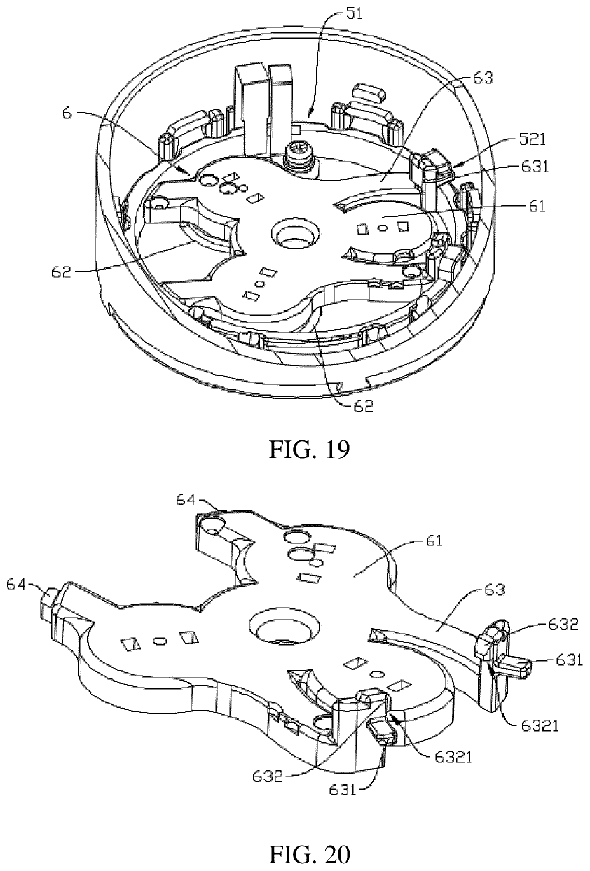

Next, referring to FIG. 19, the spring pressing assembly 6 is positioned on the top of the second planar electrode 2 and can be fixedly mounted on the pressing ring 51. After assembly, the spring pressing assembly 6 preferably does not extend beyond the top of the ring body 511. Optionally, the spring pressing assembly 6 can be made of plastic, offering a simple structure, easy assembly, and low cost, making it ideal for mass production.

Referring to FIG. 19, the spring pressing assembly 6 includes a main body 61 and a first elastic part 62 located on the side of the main body 61 facing the second planar electrode 2. The first elastic part 62 has elastic deformation capabilities, and when the main body 61 is fixed on the side of the second planar electrode 2, the first elastic part 62 is in a compressed state, applying pressure to the first planar electrode 1 and the second planar electrode 2.

The first elastic part 62 has a first contact surface 621 used to contact the second planar electrode 2 (Referring to FIG. 22,). It has two states: a natural state and a deformed state. In the natural state, the first contact surface 621 maintains a distance from the plane where the main body 61 is located. In the deformed state, the first elastic part 62 deforms, and the first contact surface 621 moves toward the plane of the main body 61, reducing the distance between the first contact surface 621 and the plane, generating an elastic force that pushes away from the plane of the main body 61.

For example, the first elastic part 62 may be a conical spring, i.e., a conical coil spring. One end of the conical spring is fixed to the side of the main body 61 facing the second planar electrode 2, while the other end is used to press against the second planar electrode 2. The face of the conical spring in contact with the second planar electrode 2 is the first contact surface 621. It is understood that a conical spring provides a more stable and controlled elastic force, offering better performance and allowing easier control over the force applied. Additionally, a compressed conical spring forms a flat structure, minimizing the space it occupies, making it more suitable for small ultrasonic sensors like the ultrasonic sensor 100. In this optional solution, referring to FIG. 22, the main body 61 features a ring-shaped groove 65 on the side facing the second planar electrode 2. The conical spring can be set and fixed into this groove 65. Preferably, the inner circumference of the groove 65 is equipped with a protruding shaft 66 and at least two wing sections 67 positioned on either side of the protruding shaft 66. The wing sections 67 are located below the groove 65, and their projections fall within the area of the groove 65 to prevent the conical spring from escaping. In this embodiment, two wing sections 67 are positioned on opposite sides of the protruding shaft 66.

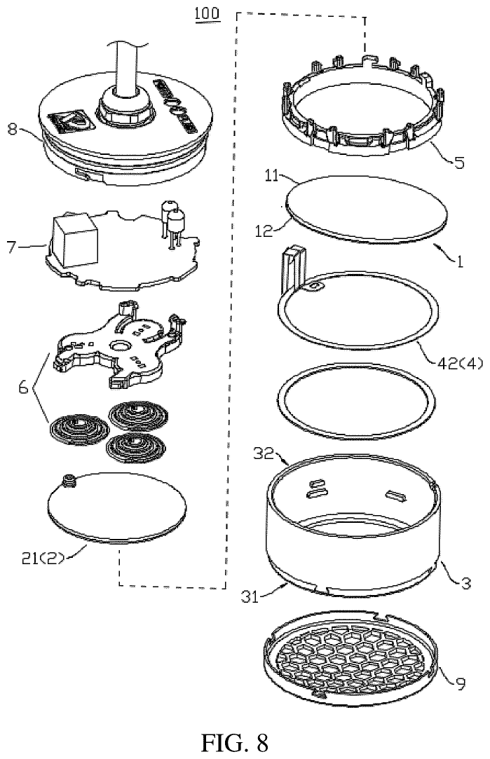

In Embodiment 2-1, referring back to FIG. 8, several conical springs are spaced apart on the main body 61, applying pressure to different areas of the second planar electrode 2 to ensure that it adheres to the first planar electrode 1 from all directions.

Of course, the first elastic part 62 can also have other structures. For instance, the first elastic part 62 may be a curved elastic strip (This feature is not shown in the drawings), with the convex surface of the strip forming the first contact surface 621. Both ends of the curved elastic strip may be attached to the main body 61, and the line connecting the two ends would run parallel to or overlap the length of the main body 61. In this optional solution, the main body 61 may feature a slot (This feature is not shown in the drawings) at the corresponding position to accommodate the deformed curved clastic strip. In its compressed state, most of the curved elastic strip would be housed in the slot, reducing the overall thickness of the sensor.

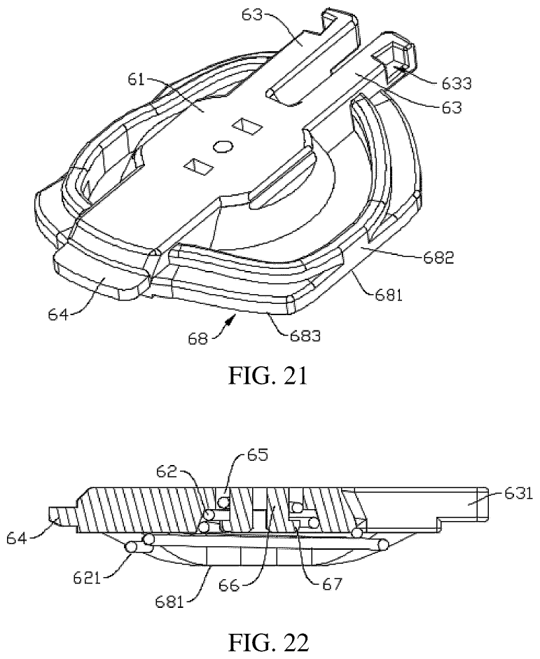

In addition, instead of using multiple conical springs, another embodiment (Embodiment 1-1) of the present application provides a single first elastic part 62 located at the bottom of the main body 61. In this Embodiment 1-1, referring to FIG. 21, the spring pressing assembly 6 further includes two second elastic parts 68 located on both sides of the main body 61 in the width direction and connected to the main body 61. The second elastic parts 68 have clastic deformation capabilities and are designed to apply downward pressure when they come into contact with the second planar electrode 2. It is understood that the first elastic part 62 is used to apply downward pressure to the central portion of the second planar electrode 2, while the second elastic parts 68 are used to apply downward pressure to areas of the second planar electrode 2 located around the periphery of the central portion.

Specifically, any second elastic part 68 is equipped with a second contact surface 681 for contacting the second planar electrode 2. The second elastic part 68 includes two states: a natural state and a deformed state. In the natural state, the second contact surface 681 is located between the main body 61 and the second planar electrode 2, maintaining a distance from the plane where the main body 61 is located. In the deformed state, the second elastic part 68 deforms, and the second contact surface 681 moves toward the main body 61, reducing the distance between the second contact surface 681 and the plane, generating an elastic force in the opposite direction.

In Embodiment 1-1, as shown in FIGS. 21 and 22, the first resilient portion 62 is a tower spring. The second elastic parts 68 include a contact part 682 and two connecting parts 683. The contact part 682 is used to engage with the second planar electrode 2, and its surface facing the second planar electrode 2 forms the second contact surface 681. In the natural state, the contact part 682 is positioned below the plane where the main body 61 is located. The connecting parts 683 link the contact part 682 and the main body 61, extending downward from the main body 61 and gradually bending toward the contact part 682. It is important to note that there may be at least one connecting part 683. In embodiments with only one connecting part 683, one end is fixed to the middle of the main body 61, and the other end is connected to the contact part 682.

Referring to FIG. 19, at least two fastening structures are positioned between the main body 61 and the pressing ring 51 to secure the spring pressing assembly 6 to the pressing ring 51. Among all the fastening structures, there can be elastic fastening structures and plug-in fastening structures that work together. It is understood that it is also possible to include only elastic fastening structures among all fastening structures, and they are not limited to the above description. As shown in FIG. 19 or FIG. 20, the elastic fastening structures and plug-in fastening structures will generally be provided to be distributed on opposite sides bounded by the center point of the main body 61 to ensure the overall mounting stability of the compression spring assembly 6.

Referring to FIG. 19, in Embodiment 2-1, the elastic fastening structures may include two second locking positions 521 set at intervals around the pressing ring 51, and two connection arms 63 that extend from the main body 61 to the corresponding second locking positions 521. The connection arms 63 have elastic deformation capabilities and are equipped with snap part 631 designed to engage the second locking positions 521. The connection arms 63 bend inward to allow the snap part 631 to enter the second locking positions 521 and then return to their natural state to secure the snap part 631 in place. Optionally, two L-shaped hook-shaped parts 523 are positioned on the top of the ring body 511, symmetrically arranged in a mirror image along the circumference of the ring body 511. The interior angles of these hook-shaped parts 523 form the second locking positions 521. Each connection arm 63 has a locking component 631 on its end farthest from the main body 61.

Referring to FIGS. 17 and 20, the plug-in fastening structures may include two plugs 64 extending from one side of the main body 61, which insert into the second mounting slots 522 formed on the inner wall of the ring body 511. The two plugs 64 are respectively used to correspondingly insert into the two second mounting slots 522. The plugs 64 secure the spring pressing assembly 6 to the pressing ring 51. However, in some embodiments, a single plug 64 and a single second mounting slot 522 may suffice.

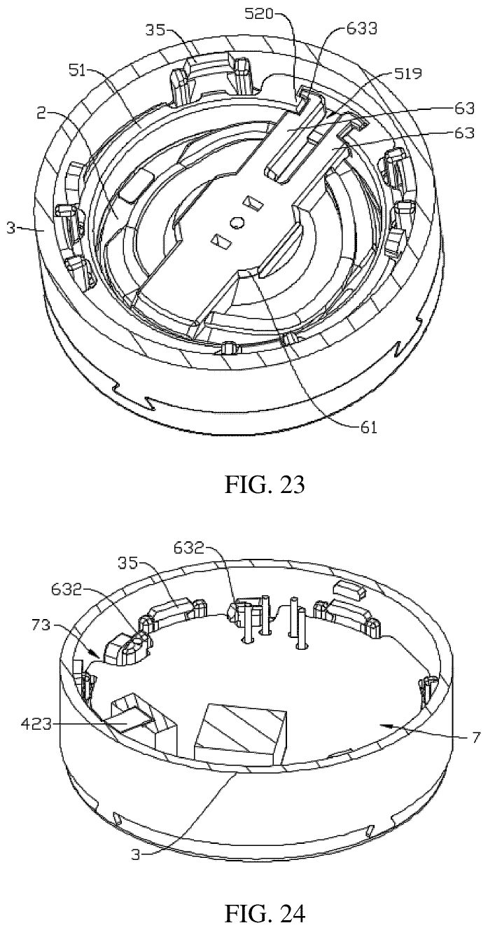

In Embodiment 1-1, as shown in FIG. 21 and FIG. 23, the clastic fastening structures may include two connection arms 63 extending outward from one side of the main body 61 and a first mounting slot 519 formed on the top of the ring body 511. The first mounting slot 519 may be recessed into the top of the ring body 511, with a first opening at the top and a second opening at the inner sidewall of the ring body 511. The first mounting slot 519 includes bumps 520 on the sidewalls to prevent the connection arms 63 from disengaging. The connection arms 63 are elastically deformed to fit into the first mounting slot 519, and the bumps 520 engage with grooves 633 formed on the connection arms 63 to secure them in place. Each of the bumps 520 is maintained with spacing between the bottom of the first mounting slot 519 and the inner sidewall of the first mounting slot 519. The two snap parts 631 are spaced apart from each other and have elastic deformation capability; the two snap parts 631 can be snapped into the first mounting slot 519 by deformation and cannot be autonomously dislodged from the first mounting slot 519 by the limiting effect of the bumps 520. Each connecting arm 63 is provided with a slot 633 for mating with the bump 520 of the first mounting slot 519, the slot 633 being recessed and shaped along the top of the connecting arm 63, having a third slot located at the top of the connecting arm 63, and a fourth slot located in the connecting arm 63 toward the sidewall of the corresponding bump 520. Understandably, during the assembly process, the two connecting arms 63 can be applied with a force that brings both of them close to each other, and then the two connecting arms 63 are subsequently fitted into the first mounting slot 519 of the pressing ring 51, and after the withdrawal of the force, the two connecting arms 63 are reset, and at the same time, by the elastic force of the first elastic portion 62, the two connecting arms 63 are displaced upwardly by a small distance, so that the bumps 520 enters into the connecting arm 63 into the slots 633 (Referring to FIG. 23). Also, the area below the two bumps 520 is essentially the same as the two second catches 521 above, and is intended for the connecting arms 63 to snap into, in other words, the area below the two bumps 520 is equivalent to the two second catches 521 above. The plug-in fastening structures for Embodiment 2-1 are similar and will not be described in detail. In this embodiment, the main body 61 is longitudinally shaped, with plug 64 located on opposite sides of the main body 61 along its length. The plug 64 and the two connecting arms 63 are located on opposite sides along the length of the main body 61.

The overall assembly of the spring pressing assembly 6 is simple and can be done with one hand. First, the plug-in fastening structures are engaged, followed by the elastic fastening structures.

Referring to FIG. 24, the main control board 7 is mounted on the top of the pressing ring 51. After assembly, the main control board 7 is positioned above the spring pressing assembly 6. The main control board 7 includes a board and multiple circuit components installed on it. These components form the boosting circuit, signal amplification and processing circuit, communication circuit, and main control chip, among others. The specific structure of these circuit components follows the prior art and will not be elaborated here.

To connect the main control board 7 to both the second planar electrode 2 and the first planar electrode 1, as shown in FIG. 24, Embodiment 2-1 uses the flexible printed circuit 42 to connect the main control board 7 to the second planar electrode 2 and the first planar electrode 1, wherein the third conductive part 423 is inserted into a predefined port on the main control board. Alternatively, as in Embodiment 1-1, shown in FIG. 6, the sensor may use a two-pin connector cable 72 to connect to the second planar electrode 2 and the first planar electrode 1. The positive and negative terminals on one side of the two-pin connector cable 72 are soldered to the second planar electrode 2 and the first planar electrode 1, while the plug on the other side is plug into the main control board 7.

In addition, a snap-fit locking structure may be provided between the main control board 7 and the pressing ring 51 or the spring pressing assembly 6 to secure the main control board 7 to the pressing ring 51 or the spring pressing assembly 6.

As shown in FIG. 24, in Embodiment 2-1, the two connection arms 63 each have an extension part 632 that extends to the top of the main control board 7. These extension parts 632 form snap corners 6321, which are positioned opposite each other. The board of the main control board 7 forms relief positions 73 to accommodate the extension parts 632 to pass through. The solid structure of the board between the two relief positions 73 is secured between the two snap corners 6321, ensuring that the main control board 7 is stably mounted on the top of the pressing ring 51.

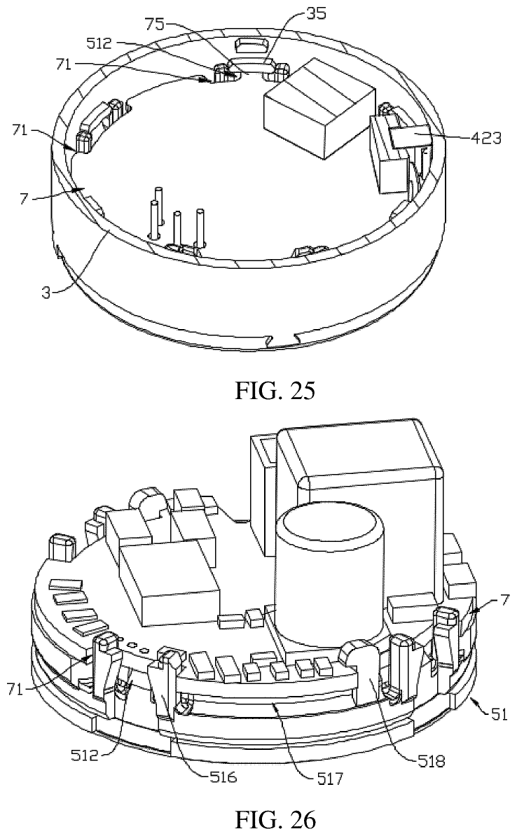

As shown in FIG. 25, the main control board 7 is positioned below the first locking block 35 and is equipped with at least one insertion part 75 that fits into the elastic channel 512. Due to the presence of the first locking block 35 above the clastic channel 512, the main control board 7 will be limited in the longitudinal and circumferential direction by the walls of the elastic channel 512 and the first locking block 35, thus effectively limiting the movement of the main control board 7. The insertion part 75, when used with the extension parts 632, ensures the main control board 7 is stably mounted above the pressing ring 51.

Thus, Embodiment 2-1 provides two snap-fit locking structures. The first includes the extension parts 632 on the connection arms 63 of the spring pressing assembly 6, and the solid structure of the main control board 7 between the relief positions 73. The second includes the elastic channel 512 and the insertion part 75 of the main control board 7.

This application also provides alternative snap-fit locking structures, such as those shown in FIG. 26 for Embodiment 2-3, where the outer perimeter of the main control board 7 is equipped with several circumferentially spaced relief notches 71 to avoid the first locking blocks 35 and the snap members 516 forming the elastic channels 512. Additionally, a protrusion 518 is formed between the elastic channels 512 on the ring body 511, which, together with the snap members 516, form the first locking position 517. In other words, the snap-fit locking structure includes the solid structure of the main control board 7 between the relief notches 71 and the first locking position 517 formed between the snap members 516 and the protrusions 518 on the pressing ring 51. In other words, the snap-fit connection structure may include the solid structure of the board of the control board 7 between two relief notches 71, and the first locking position 517 formed on the pressing ring 51. It is understood that, to leave enough space for the control board 7 to snap into place, the protrusion 518 is often inclined toward one of the elastic channel 512 and, together with the snap members 516 forming the other clastic channel 512, creates the first locking position 517. This utility model utilizes the cooperation between the snap members 516 and the protrusion 518 to form the first locking position 517, which simplifies the structure of the pressing ring 51.

The use of the protrusion 518 in conjunction with the snap members 516 helps to simplify the structure of the pressing ring 51.

Further, as shown in FIG. 26, the protrusion 518 has an L-shaped structure. The vertical section of the protrusion 518 is formed on the ring body 511, while the horizontal section extends in the direction of the snap members 516. The protrusion 518 prevents the main control board 7 from detaching from the first locking position 517, either vertically or circumferentially, thereby enhancing the stability of the main control board's installation.

In Embodiment 2-2, as described earlier in FIG. 18, since the pressing ring 51 does not include the snap members 516, the snap-fit locking structure can be created using raised protuberance 55 on the top of the pressing ring 51. The protuberance 55, in combination with the protrusions 518, form the first locking position 517 by being circumferentially spaced on the ring body 511.

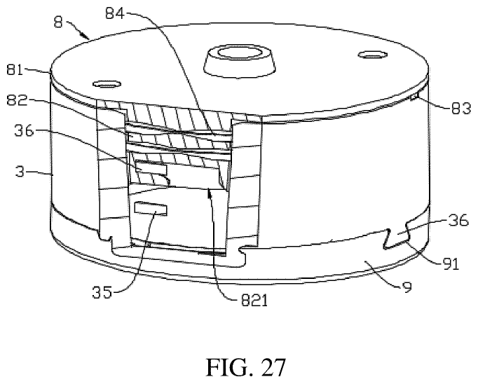

Referring to FIG. 27, the back cover 8 is installed on the second end 32 of the housing 3, sealing the second end 32. The back cover 8 can be mounted using various methods such as interference fit, screwing, or snapping.

As shown in FIG. 27, the back cover 8 includes a back plate 81 and a cylindrical section 82 located on the back plate 81. The cylindrical section 82 has several positioning slots 821 on its outer surface, designed to engage with the second locking blocks 36 inside the housing 3. This ensures that the back cover 8 is securely installed.

The positioning slots 821 have an L-shaped structure, including a fifth slot opening for the second locking block 36 to enter and an internal portion that prevents the second locking block 36 from disengaging. During installation, the fifth slot opening is aligned with the second locking block 36, allowing the back cover 8 to be smoothly inserted into the housing 3. A slight rotation moves the second locking block 36 into the internal portion of the positioning slot 821, locking it in place.

Referring again to FIG. 27, a raised boss 83 is located at the edge of the back plate 81 where it connects to the cylindrical section 82. When the back cover 8 is installed, the raised boss 83 fits into the limiting groove 37 on the top end of the housing 3. This prevents the back cover 8 from rotating and ensures that it remains securely mounted.

Additionally, one or more sealing rings 84 may be placed around the outer perimeter of the cylindrical section 82 to provide a sealing effect, such as waterproofing.

Returning to FIGS. 5 and 6, the ultrasonic sensor 100 also includes installation accessories used to fix the control wires 74 connected to the main control board 7. In this embodiment, the installation accessories may include a nut 85, elastic washer 86, rubber sleeve 87, screw tube 88, and a nut (This feature is not marked in the drawings). The components can be assembled as shown, with the elastic washer 86 fitted to the lower end of the screw tube 88, the rubber sleeve 87 inserted into the screw tube 88, and the nut 85 loosely attached. The assembled screw tube 88 is mounted on the top of the back cover 8, with its lower end passing through the back cover 8 and secured in place using a nut. The control wires 74 pass through the screw tube 88 and are soldered to the main control board 7. Alternatively, the ends of the control wires 74 can be equipped with plugs that directly connect to sockets on the main control board 7, facilitating easy connection.

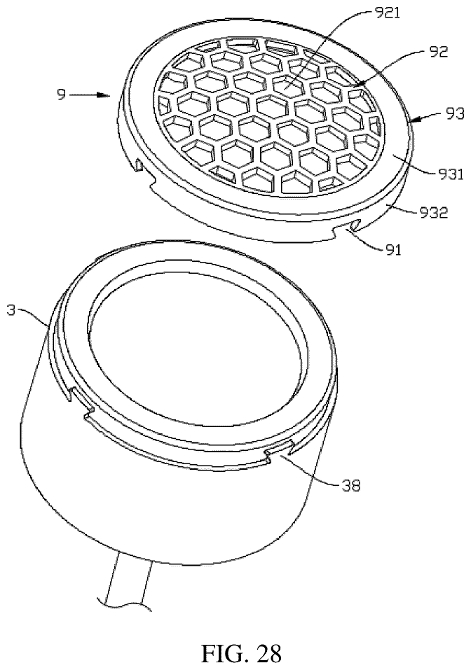

Referring again to FIG. 28, the mesh cover 9 is detachably installed on the first end 31 of the housing 3. It is understood that the mesh cover 9 is an optional component and is applied to this embodiment to prevent accidental contact with the film, offering protection and allowing water drainage through the mesh holes. In other embodiments, the mesh cover 9 can be removed, depending on the sensitivity requirements of the ultrasonic sensor 100. For example, removing the mesh cover 9 can increase the sensor's sensitivity.

The mesh cover 9 is secured to the housing 3 using a fixed structure. As shown in FIG. 28, the fixed structure includes several third locking blocks 38 arranged circumferentially around the outer perimeter of the first end 31 of the housing 3 and corresponding locking slots 91 arranged on the mesh cover 9. Each locking slot 91 snaps into one of the third locking blocks 38 to secure the mesh cover 9 in place. The shape of the locking slots 91 corresponds to the shape of the third locking blocks 38, with each locking slot 91 featuring an opening on the top edge of the mesh cover 9. The length of the opening is shorter than the length of the bottom wall of the locking slot 91 to ensure a secure fit.

Of course, other fixed structures are possible. For example, an external thread (This feature is not shown in the drawings) could be formed on the outer perimeter of the first end 31 of the housing 3, with a corresponding internal thread on the mesh cover 9.

Further, as shown in FIG. 28, the mesh cover 9 includes a curved surface portion 92 with several mesh holes 921 that allow ultrasonic waves to pass through. The curved surface portion 92 can either protrude outward from the ultrasonic sensor 100, forming a convex surface, or be recessed inward, forming a concave surface (as shown in FIG. 32).

It is understood that the mesh cover 9 not only protects the internal structure of the ultrasonic sensor but also impacts the sensor's sensitivity by partially blocking the ultrasonic waves. Specifically, when the mesh cover 9 has a concave surface, it can further reduce the sensor's sensitivity, narrow the ultrasonic beam angle, and enhance the sensor's focus. Conversely, when the curved surface portion 92 of the mesh cover 9 is in a convex structure, it can effectively limit the attenuation of the ultrasonic waves, and amplifies the ultrasonic signal, and improves the sensor's sensitivity. Therefore, depending on the required sensitivity of the ultrasonic sensor 100, a convex or concave mesh cover 9 can be selected.

The following description of the present mesh cover 9 will first be carried out as an example of improving the sensitivity of the ultrasonic sensor.

In some embodiments, referring to FIG. 28, the shape of the mesh cover 9 may be circular. Of course, the shape of the net cover 9 may also be square, or other shapes; this can be adapted according to the shape of the ultrasonic sensor, and will not be limited herein.

As shown in FIG. 28, the outer diameter R1 of the mesh cover 9 may range from 25 mm to 35 mm, for example, 30 mm. Of course, the outer diameter R1 can be adjusted based on the design of the ultrasonic sensor.

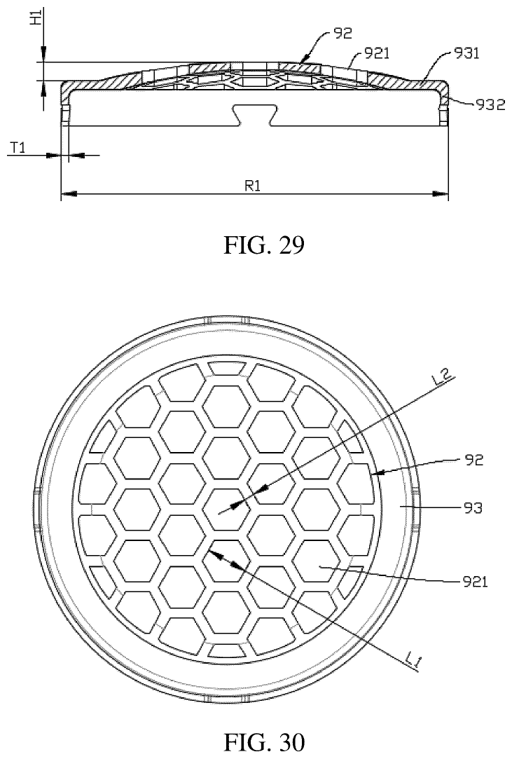

With reference to FIG. 29, the mesh cover 9 may include a curved surface portion 92, and a mounting portion 93 disposed circumferentially around the perimeter of the curved surface portion 92, annularly shaped, which provides a base for the mesh cover 9 to be mounted on the housing 3 of the ultrasonic transducer.

The curved surface portion 92 can be made of plastic to facilitate control over its dimensions and the curvature of the protrusion. Alternatively, the curved surface portion 92 can also be made of metal, manufactured using weaving, laser cutting, or stamping processes.

The mounting portion 93 can also be made of plastic. When the curved surface portion 92 is plastic, the mounting portion 93 can be integrally formed with it. If the curved surface portion 92 is metal, the mounting portion 93 and the curved surface portion 92 can be formed using a metal insert molding process, or the curved surface portion 92 can be fixed to the inner perimeter of the mounting portion 93 by snapping or embedding. Of course, the mounting portion 93 can also be made of other materials, such as metal, without limitation.

As shown in FIG. 29, the thickness T1 of the curved surface portion 92 can range from 0.5 mm to 1 mm, such as 0.6 mm or 0.8 mm. It is understood that increasing the thickness T1 of the curved surface portion 92 can result in greater attenuation of the ultrasonic signal, which may reduce the sensor's sensitivity.

As shown in FIG. 17, the curved surface portion 92 of the mesh cover 9 is convex, forming an arch. In the longitudinal section, the shape may be an arc segment. Of course, the convex structure can also be a parabola or part of a catenary curve in the longitudinal section, which is not specifically limited here.

The height H1 of the convex part of the curved surface portion 92 can range from 0.5 mm to 1.5 mm. It is understood that, as shown in FIG. 17, the height H1 of the convex part refers to the distance between the highest point of the curved surface portion 92 and the end surface of the mounting portion 93 (the end surface that faces away from the housing 3 of the ultrasonic sensor 100). Optionally, the convex height H1 of the convex structure can be set to 0.5 mm, 1.0 mm, 1.25 mm, or 1.5 mm, with a preferred range of 1.25 mm to 1.5 mm for optimal ultrasonic amplification effects.

As shown in FIG. 30, the mesh holes 921 in the curved surface portion 92 are uniformly arranged. Optionally, the mesh holes 921 can be arranged in a honeycomb pattern. Of course, the mesh holes 921 can also be arranged in a matrix or other patterns, which is not specifically limited here.

Optionally, each of mesh holes 921 can be a regular polygon, such as a square or hexagon. Of course, the mesh holes 921 can also be circular or irregular polygons, or other shapes, which are not specifically limited. Furthermore, the shapes of each mesh hole 921 can be the same or different.

Optionally, as shown in FIG. 30, the distance L1 between two opposite sides of each mesh hole 921 can range from 2.8 mm to 3.5 mm. Further, the distance L1 between opposite sides of each mesh hole 921 can be, for example, 3 mm or 3.2 mm. For example, in an embodiment where the mesh hole 921 is a regular polygon, the distance L1 can be defined as the distance between two opposite sides of the polygon. In an embodiment where the mesh hole 921 is circular, the distance L1 can be the diameter of the circle passing through the center of the mesh hole 921.

Optionally, as shown in FIG. 30, the distance L2 between two adjacent mesh holes 921 can range from 0.6 mm to 1 mm. Further, the distance L2 can be 0.8 mm. For example, in an embodiment where the mesh holes 921 are regular polygons, the distance L2 can refer to the thickness of the material separating the mesh holes 921. In an embodiment where the mesh holes 921 are circular, the distance L2 can refer to the shortest distance between two adjacent mesh holes 921. It is understood that the material between the mesh holes 921 should be kept as thin as possible to minimize obstruction of the ultrasonic waves, thereby enhancing the amplification effect.

And the structure of the mounting portion 93, as shown in FIG. 28, the mounting portion 93 can include a flat part 931 located at the edge of the curved surface portion 92. The flat part 931 serves as the interface for mounting the mesh cover 9 onto the ultrasonic sensor housing 3.

The mounting portion 93 further includes an assembly part 932 that extends from the end surface of the flat part 931. The assembly part 932 extends perpendicularly from the inner surface of the flat part 931.

Experimental data provided below illustrates the effect of using a convex mesh cover 9 in increasing the sensitivity of the ultrasonic sensor 100:

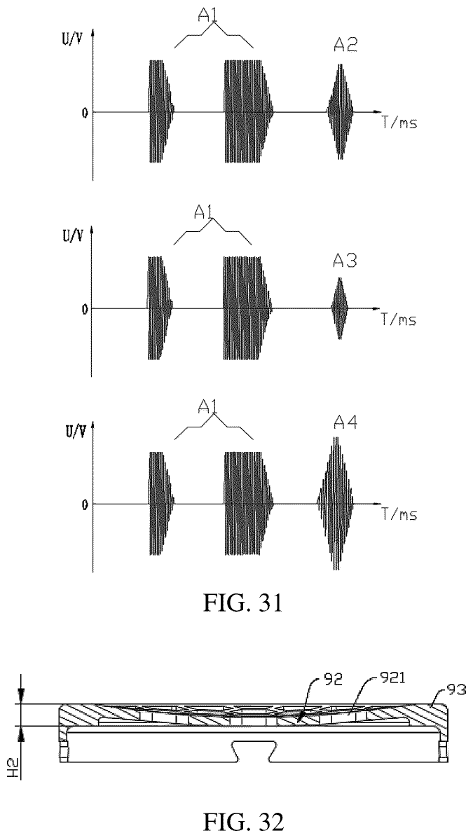

As shown in FIG. 31, the figure displays the reflection waveforms in three different scenarios: when no mesh cover 9 is used, when a mesh cover 9 with a flat structure is used, and when a convex mesh cover 9 is used. The reflection waveforms are denoted by A2, A3, and A4, respectively.

As seen in FIG. 31, after the ultrasonic sensor emits the same transmitted wave A1 toward the same size obstacle, the reflection waveform A3 from the flat mesh cover 9 has the smallest peak and narrowest width. The reflection waveform A2 from the sensor without a mesh cover 9 is larger than A3, and the reflection waveform A4 from the sensor with the convex mesh cover 9 is even larger than A2. This demonstrates that using a convex mesh cover 9 amplifies the sensitivity of the ultrasonic sensor 100 rather than limiting it.

Now turning to examples where the curved surface portion 92 is concave, as shown in FIG. 32, the thickness T1 of the curved surface portion 92, the arrangement of the mesh holes 921, the size of the mesh holes 921, and the distance L2 between adjacent mesh holes 921 can be similar to those described in the convex embodiment. The depth H2 of the concave portion, defined as the distance between the lowest point of the curved surface portion 92 and the end surface of the mounting portion 93 (the end surface that faces away from the ultrasonic sensor housing 3), can also be similar to the convex height H1 mentioned above. It is understood that merely having a concave structure instead of a flat structure already reduces the sensitivity and narrows the ultrasonic beam, achieving a focusing effect.

Furthermore, the sensitivity can be reduced by increasing the thickness T1 of the curved surface portion 92, reducing the size of the mesh holes 921, increasing the distance L2 between adjacent mesh holes 921, or adjusting the depth H2 of the concave surface.

It should be understood that the above embodiments merely represent preferred implementations of the present invention. These descriptions are specific and detailed but are not intended to limit the scope of the patent claims. Modifications and variations may be made by those skilled in the art without departing from the spirit and scope of the present invention. All equivalent substitutions and modifications made within the scope of the claims should be regarded as falling within the scope of the present invention.

What is claimed is:

1. An ultrasonic sensor, comprising:
a housing, cylindrical in shape, provided with a supporting part inside and a connecting opening connected to the outside;
a first planar electrode placed on the supporting part and positioned opposite to the connecting opening;
a second planar electrode, positioned opposite to the first planar electrode, wherein a surface of the second planar electrode is at least partially affixed to a surface of the first planar electrode backward to the supporting part, and insulated from each other to form a stable planar capacitor;
wherein the first planar electrode comprises an insulating film and a first conductive layer arranged on the insulating film; and the second planar electrode comprises at least a conductive substrate; the first conductive layer is insulated from the conductive substrate.

2. The ultrasonic sensor according to claim 1, wherein the insulating film is a plastic film, and the thickness of the insulating film is in the range of 1 μm to 50 μm;
the first conductive layer is a metal layer attached to the surface of the plastic film, and the thickness of the first conductive layer is in the range of 1 nm to 20 μm.

3. The ultrasonic sensor according to claim 1, wherein the conductive substrate is a PCB board;
or, the conductive substrate is a metal plate, and the thickness of the metal plate is in the range of 0.001 mm to 20 mm.

4. The ultrasonic sensor according to claim 1, wherein the first conductive layer is arranged on one side of the insulating film facing the second planar electrode, and an insulating layer is provided between the first conductive layer and the conductive substrate, with the insulating film isolating the first conductive layer from the external environment.

5. The ultrasonic sensor according to claim 4, wherein the second planar electrode is provided with at least one groove on the surface facing the first planar electrode, and the at least one groove is located at the edge of the second planar electrode,
and the ultrasonic sensor further comprises a conductive plate supplying power to the first planar electrode, the conductive plate being placed on one side of the first planar electrode backward to the supporting part and adhered to the first conductive layer.

6. The ultrasonic sensor according to claim 1, wherein the first conductive layer is arranged on one side of the insulating film facing away from the second planar electrode;
the ultrasonic sensor further comprises a flexible printed circuit, wherein the flexible printed circuit comprises a first conductive part electrically connected to the first conductive layer and a third conductive part used for connecting electrical signals; the first conductive part is arranged between the first planar electrode and the supporting part, and the third conductive part transmits electrical signals to the first conductive layer through the first conductive part.

7. The ultrasonic sensor according to claim 6, wherein the flexible printed circuit further comprises a second conductive part electrically connected to the conductive substrate; the third conductive part transmits electrical signals to the conductive substrate through the second conductive part.

8. The ultrasonic sensor according to claim 1, wherein a surface of the second planar electrode facing the first planar electrode is provided with a silkscreen layer or dents for forming a textured structure.

9. The ultrasonic sensor according to claim 1, wherein the ultrasonic sensor further comprises a pressing ring, the pressing ring being installed on a surface of the first planar electrode facing the second planar electrode; moreover, a snap-fit structure is provided between the pressing ring and the housing to press the first planar electrode tightly against the supporting part.

10. The ultrasonic sensor according to claim 9, wherein the snap-fit structure comprises a plurality of elastic channels arranged circumferentially on the pressing ring, and a plurality of first locking blocks provided on the inner circumferential side of the housing, each corresponding to the elastic channels;
some sidewalls of each elastic channel have elastic deformation capability, and the width of an opening of the elastic channel farthest from the first planar electrode is smaller than the length of the first locking block;
the pressing ring utilizes the elasticity of the sidewalls of the elastic channel to pass over the first locking block and snap into the side of the first locking block facing the first planar electrode; wherein, an end wall of channel of the elastic channel formed around the opening resists the first locking block.

11. The ultrasonic sensor according to claim 10, wherein the pressing ring is further provided with a receiving area on the side of the elastic channel opposite to the first planar electrode, the first locking block passing through the elastic channel is located in the receiving area, and it can contact the sidewall of the receiving area to limit the circumferential movement of the pressing ring;
the pressing ring comprises a ring body and a plurality of snap-fit components arranged circumferentially on the periphery of the ring body; each set of snap-fit components comprises two snap members spaced circumferentially along the ring body, with an elastic channel and a receiving area formed between the two snap members;
wherein the deformation state of the elastic channel is: each of the two is inclined in a direction away from the other, or, two sidewalls of the two snap members facing each other are elastic walls.

12. The ultrasonic sensor according to claim 9, wherein the snap-fit structure comprises a plurality of inclined wedges arranged circumferentially on the periphery of the pressing ring, and a plurality of first locking blocks provided on the inner circumferential side of the housing, each corresponding to the elastic channels;
each inclined wedge has a pre-assembly state and an assembly state, wherein the pre-assembly state has the inclined wedge at least partially positioned at the same height as the first locking block, and the assembly state is when the pressing ring rotates circumferentially around the housing, causing the inclined wedge to snap into the side of the first locking block facing the supporting part.

13. The ultrasonic sensor according to claim 9, wherein the ultrasonic sensor includes a spring assembly, which is fixed relative to the side of the second planar electrode facing away from the first planar electrode and abuts the second planar electrode, applying a force to press the second planar electrode tightly against the first planar electrode;
the spring assembly comprises a main body part and at least one first elastic part positioned between the main body part and the second planar electrode, wherein the first elastic part has the capability of elastic deformation and is in a compressed state when the main body part is fixed on one side of the second planar electrode, thereby achieving tight pressing.

14. The ultrasonic sensor according to claim 13, wherein each side of the main body part is provided with a first snap-fit structure and a second snap-fit structure with respect to the pressing ring to fix the spring assembly to the pressing ring;
wherein the first snap-fit structure comprises two second locking positions arranged at intervals along the circumference of the pressing ring, and two connecting arms extending from the main body part to correspond to the second locking positions, the two connecting arms having elastic deformation capability, which allows them to move closer together in a deformed state to enter the corresponding second locking positions, and snap into the second locking positions in a natural state;
the second snap-fit structure is structurally identical to the first snap-fit structure; or, the second snap-fit structure comprises a plug set on either the main body part or the pressing ring, and a second mounting slot set on the other, where the plug is inserted into the second mounting slot.

15. The ultrasonic sensor according to claim 14, wherein the pressing ring is provided with a first mounting slot for the two connecting arms to partially insert, and two bumps are set on the walls of the first mounting slot to form two second locking positions; each connecting arm has a slot at the top, and the slot snaps onto the bumps after part of the connecting arm is inserted into the first mounting slot;
or, the pressing ring comprises a ring body and two hook-shaped parts positioned on the side of the ring body opposite the first planar electrode, where the two hook-shaped parts form the second locking positions, and the two hook-shaped parts are mirror-symmetrically arranged in the circumferential direction of the pressing ring; each connecting arm is further provided with a snap part for insertion into the second locking positions.

16. The ultrasonic sensor according to claim 13, wherein the spring assembly comprises multiple first elastic parts, which are arranged at intervals between the main body part and the second planar electrode;
or, the spring assembly comprises a single first elastic part and two second elastic parts positioned on both sides of the main body part in the width direction; the second elastic parts have elastic deformation capability, and are in a deformed state when the main body part is fixed on the second planar electrode, thereby achieving tight pressing; the second elastic parts include contact parts for abutting the second planar electrode, and connecting parts linking the contact parts to the main body part; there is a distance between the contact parts and the plane of the main body part, and one end of the connecting parts, which are connected to the contact parts, moves relative to the plane of the main body part when the contact parts are pressed, generating elastic force.

17. The ultrasonic sensor according to claim 14, wherein the ultrasonic sensor further includes a control board for outputting electrical signals; the control board is installed on the side of the spring assembly opposite to the second planar electrode;
the two connecting arms are each provided with extension parts extending from the control board on the side opposite to the pressing ring, and the extension parts have snap corners that hold part of the control board between the two extension parts;
the control board is further provided with at least one insertion part for insertion into the elastic channel.

18. The ultrasonic sensor according to claim 9, wherein the ultrasonic sensor further comprises a control board for outputting electrical signals; a third snap-fit structure is provided between the pressing ring and the control board for mounting the control board onto the pressing ring;
wherein the outer circumferential edge of the control board is provided with several relief notches arranged at intervals along the circumference, and the third snap-fit structure comprises a solid structure located between two adjacent relief notches on the control board, and a first locking position formed on the pressing ring, with the solid structure snapping into the first locking position.

19. The ultrasonic sensor according to claim 1, wherein the ultrasonic sensor further comprises a mesh cover, which is detachably mounted on one end of the housing close to the first planar electrode; a fixing structure is provided between the mesh cover and the housing to fix the mesh cover to the housing;
the mesh cover includes a curved surface, and the curved surface is provided with multiple mesh holes; wherein the curved surface is a convex structure protruding outward from the ultrasonic sensor, or a concave structure recessed inward toward the ultrasonic sensor.

20. The ultrasonic sensor according to claim 19, wherein the multiple mesh holes are evenly arranged on the curved surface; wherein the distance L1 between the two opposite sides of each mesh hole is in the range of 2.8 mm to 3.5 mm, and/or the distance L2 between the nearest two points of two adjacent mesh holes is in the range of 0.6 mm to 1 mm, and/or the thickness T1 of the curved surface is in the range of 0.5 mm to 1 mm;
moreover, the mesh cover further comprises an annular mounting portion set at the peripheral edge of the curved surface; wherein the height H1 from the highest point of the curved surface to the end face of the mounting portion is in the range of 0.5 mm to 1.5 mm, or, the depth H2 from the lowest point of the curved surface to the end face of the mounting portion is in the range of 0.5 mm to 1.5 mm.
